(19) United States
(12) Patent Application Publication
(10) Pub. No.: US 2025/0370223 A1
(43) Pub. Date: Dec. 4, 2025

(54) OPTICAL PHOTOGRAPHY LENS ASSEMBLY

(71) Applicant: ZHEJIANG SUNNY OPTICS CO., LTD, Zhejiang (CN)

(72) Inventors: Yining DAI, Zhejiang (CN); Xin WANG, Zhejiang (CN); Liefeng ZHAO, Zhejiang (CN); Fang ZHANG, Zhejiang (CN); Saifeng LYU, Zhejiang (CN); Peng GAO, Zhejiang (CN)

(73) Assignee: ZHEJIANG SUNNY OPTICS CO., LTD, Zhejiang (CN)

(21) Appl. No.: 18/982,440

(22) Filed: Dec. 16, 2024

(30) Foreign Application Priority Data
May 31, 2024 (CN) 202410702404.9

(51) Int. Cl. G02B 13/00; G02B 9/62

(52) U.S. Cl. CPC G02B 13/0045; G02B 9/62

(57) ABSTRACT

An optical photography lens assembly is provided, including a lens barrel, and a lens group and at least one spacing element accommodated within the lens barrel, where the lens group includes: a first lens, a second lens, a third lens, a fourth lens, a fifth lens, and a sixth lens, each of the first to sixth lenses having a refractive power; and the at least one spacing element includes a third spacing element disposed between the third lens and the fourth lens; where, a radius of curvature R5 of an object-side surface of the third lens and a radius of curvature R6 of an image-side surface of the third lens satisfy: 1.5<R6/R5<2.0; and an effective focal length f3 of the third lens and an inner diameter d3s of an object-side surface of the third spacing element satisfy: 3.2<f3/d3s<4.2.

### CROSS-REFERENCE TO RELATED APPLICATIONS

This application claims the benefit from Chinese Patent Application No. 202410702404.9, filed on May 31, 2024 before the China National Intellectual Property Administration, the entire disclosure of which is incorporated herein by reference in its entity.

### TECHNICAL FIELD

The present disclosure relates to the field of optical elements, and in particular, to an optical photography lens assembly including a plurality of lenses.

### BACKGROUND

Small infrared lens assemblies are widely used in feature recognition electronic terminal devices, having features such as non-contact operation, portability, and all-weather capability. These lens assemblies have high requirements for detailed recognition of the subject being photographed.

Therefore, in order to meet the need for detailed recognition of the subject, there is a need to design an optical photography lens assembly that balances both high resolution and high relative illuminance.

### SUMMARY

According to an aspect of the present disclosure, an optical photography lens assembly is provided, including a lens barrel having an accommodation space, and a lens group and at least one spacing element accommodated within the lens barrel, where, the lens group includes: a first lens having a refractive power, a second lens having a refractive power, a third lens having a refractive power, a fourth lens having a refractive power, a fifth lens having a refractive power, and a sixth lens having a refractive power, disposed sequentially along an optical axis from an object side to an image side; the at least one spacing element includes a third spacing element disposed between the third lens and the fourth lens and in direct contact with an image side of the third lens; where, a radius of curvature R5 of an object-side surface of the third lens and a radius of curvature R6 of an image-side surface of the third lens satisfy: 1.5<R6/R5<2.0; and an effective focal length f3 of the third lens and an inner diameter d3s of an object-side surface of the third spacing element satisfy: 3.2<f3/d3s<4.2.

In one or more embodiments, the at least one spacing element further includes a fifth spacing element disposed between the fifth lens and the sixth lens and in direct contact with an image side of the fifth lens, and a radius of curvature R10 of an image-side surface of the fifth lens, a refractive index N5 of the fifth lens, and an inner diameter d5s of an object-side surface of the fifth spacing element satisfy: −75.0<R10*N5/d5s<−18.0.

In one or more embodiments, the at least one spacing element further includes a first spacing element disposed between the first lens and the second lens and in direct contact with an image side of the first lens, and a spacing EP01 between a front-end surface of the lens barrel and the first spacing element, a center thickness CT1 of the first lens on the optical axis and a center thickness CT2 of the second lens on the optical axis satisfy: 3.5<(EP01+CT2)/CT1<5.0.

In one or more embodiments, the at least one spacing element further includes a first spacing element disposed between the first lens and the second lens and in direct contact with an image side of the first lens, and a second spacing element disposed between the second lens and the third lens and in direct contact with an image side of the second lens, and a spacing EP12 between the first spacing element and the second spacing element, a center thickness CT1 of the first lens on the optical axis and a center thickness CT2 of the second lens on the optical axis satisfy: 0.9<EP12/CT2<1.1; and 1.4<CT2/CT1≤2.3.

In one or more embodiments, the at least one spacing element further includes a second spacing element disposed between the second lens and the third lens and in direct contact with an image side of the second lens, and an effective focal length f2 of the second lens, a refractive index N2 of the second lens and an inner diameter d2s of an object-side surface of the second spacing element satisfy: 5.5<f2*N2/d2s<6.5.

In one or more embodiments, the at least one spacing element further includes a second spacing element disposed between the second lens and the third lens and in direct contact with an image side of the second lens, and a combined focal length f12 of the first lens and the second lens, an outer diameter D2m of an image-side surface of the second spacing element, and an inner diameter d2m of the image-side surface of the second spacing element satisfy: 7.0<f12/(D2m−d2m)<17.5.

In one or more embodiments, the at least one spacing element further includes a second spacing element disposed between the second lens and the third lens and in direct contact with an image side of the second lens, and an air spacing T23 between the second lens and the third lens on the optical axis, an air spacing T34 between the third lens and the fourth lens on the optical axis, a center thickness CT3 of the third lens on the optical axis, and a spacing EP23 between the second spacing element and the third spacing element satisfy: 1.5<(T23+CT3+T34)/EP23<2.0.

In one or more embodiments, the at least one spacing element further includes a fourth spacing element disposed between the fourth lens and the fifth lens and in direct contact with an image side of the fourth lens, and a fifth spacing element disposed between the fifth lens and the sixth lens and in direct contact with an image side of the fifth lens, and a spacing EP45 between the fourth spacing element and the fifth spacing element, a maximal thickness CP5 of the fifth spacing element, and a center thickness CT5 of the fifth lens on the optical axis satisfy: 1.5<(EP45+CP5)/CT5<2.5.

In one or more embodiments, the at least one spacing element further includes a fifth spacing element disposed between the fifth lens and the sixth lens and in direct contact with an image side of the fifth lens, and a sixth spacing element disposed an image side of the sixth lens and in direct contact with the image side of the sixth lens, and an air spacing T56 between the fifth lens and the sixth lens on the optical axis and a spacing EP56 between the fifth spacing element and the sixth spacing element satisfy: 0.921 T56/EP56<2.1.

In one or more embodiments, the at least one spacing element further includes a first spacing element disposed between the first lens and the second lens and in direct contact with an image side of the first lens, and a radius of curvature R1 of an object-side surface of the first lens, an inner diameter d1s of an object-side surface of the first spacing element, and an inner diameter dim of an image-side surface of the first spacing element satisfy: 31.0<R1/(d1s−d1m)<33.5.

In one or more embodiments, the at least one spacing element further includes the first spacing element disposed between the first lens and the second lens and in direct contact with the image side of the first lens, and a second spacing element disposed between the second lens and the third lens and in direct contact with an image side of the second lens, and a spacing EP12 between the first spacing element and the second spacing element and the spacing EP01 between the front-end surface of the lens barrel and the first spacing element satisfy: 0.5<EP12/EP01<1.0.

In one or more embodiments, the at least one spacing element further includes a fourth spacing element disposed between the fourth lens and the fifth lens and in direct contact with an image side of the fourth lens and a radius of curvature R7 of an object-side surface of the fourth lens, a radius of curvature R8 of an image-side surface of the fourth lens, an outer diameter D4s of an object-side surface of the fourth spacing element, and an outer diameter D4m of an image-side surface of the fourth spacing element satisfy: 1.5<D4s/R7+D4m/R8≤2.5.

In one or more embodiments, the at least one spacing element further includes a fifth spacing element disposed between the fifth lens and the sixth lens and in direct contact with an image side of the fifth lens, and a radius of curvature R9 of an object-side surface of the fifth lens, a refractive index N5 of the fifth lens, and an outer diameter D5s of an object-side surface of the fifth spacing element satisfy: 0.4<R9*N5/D5s<0.6.

In one or more embodiments, the at least one spacing element further includes a fifth spacing element disposed between the fifth lens and the sixth lens and in direct contact with an image side of the fifth lens, and an effective focal length f6 of the sixth lens and an inner diameter d5m of an image-side surface of the fifth spacing element satisfy: −3.5<f6/d5m<−0.9.

In one or more embodiments, a maximal height L of the lens barrel along a direction of the optical axis and a sum of center thicknesses ΣCT of all lenses in the lens group on the optical axis satisfy: 1.6<L/ΣCT<1.8.

In one or more embodiments, an outer diameter D3s of the object-side surface of the third spacing element, the radius of curvature R5 of the object-side surface of the third lens, the radius of curvature R6 of the image-side surface of the third lens, and an outer diameter D3m of an image-side surface of the third spacing element satisfy: 1.7<D3s/R5+D3m/R6<2.9.

In one or more embodiments, the at least one spacing element further includes the fourth spacing element disposed between the fourth lens and the fifth lens and in direct contact with the image side of the fourth lens, and a combined focal length f45 of the fourth lens and the fifth lens, the outer diameter D4s of the object-side surface of the fourth spacing element, and an inner diameter d4s of the object-side surface of the fourth spacing element satisfy: 2.0<f45/(D4s−d4s)<6.5.

In one or more embodiments, the at least one spacing element further includes a fifth spacing element disposed between the fifth lens and the sixth lens and in direct contact with an image side of the fifth lens, and a combined focal length f56 of the fifth lens and the sixth lens and an outer diameter D5m of an image-side surface of the fifth spacing element satisfy: 0.8<f56/D5m<2.4.

In one or more embodiments, the at least one spacing element further includes a fifth spacing element disposed between the fifth lens and the sixth lens and in direct contact with an image side of the fifth lens, and an effective focal length f5 of the fifth lens, a radius of curvature R10 of an image-side surface of the fifth lens, and an inner diameter d5s of an object-side surface of the fifth spacing element satisfy: 1.1<f5/R10+f5/d5s<3.0.

The optical photography lens assembly provided in the present disclosure uses a six-piece lens group, by reasonably controlling the number of lenses having refractive powers in the lens group as well as distribution of the refractive powers of the lenses, the lens assembly can have a small field curvature and a low dispersion, thereby improving a relative illumination (RI), however, this also results in a sensitive third lens and easy generation of stray light in structural portions. Satisfying 1.5<R6/R5<2.0 and 3.0<f3/d3s<4.2 is conducive to improving the field curvature of the optical structure and correcting aberrations, achieving the design of the lens assembly having small field curvature and low astigmatism as well as small aberrations, which ensures a high imaging resolution, and improves the ability of terminal electronic devices to recognize details; and is also conducive to improving the RI, while reducing the sensitivity of the third lens, improving stray light in a structural area of the third lens, thereby improving an imaging quality.

### BRIEF DESCRIPTION OF THE DRAWINGS

By reading detailed descriptions of non-limiting embodiments given with reference to the following accompanying drawings, other features, objectives and advantages of the present disclosure will become more apparent:

FIG. 1 illustrates a schematic diagram of a structure and some parameters of an optical photography lens assembly according to implementations of the present disclosure;

FIG. 2 illustrates a schematic structural diagram of an optical photography lens assembly according to Embodiment 1 of the present disclosure;

FIG. 3 illustrates a schematic structural diagram of an optical photography lens assembly according to Embodiment 2 of the present disclosure;

FIGS. 4A-4C respectively illustrate a longitudinal aberration curve, an astigmatic curve and a lateral color curve of the optical photography lens assembly according to Embodiment 1 and Embodiment 2 of the present disclosure;

FIG. 5 illustrates a schematic structural diagram of an optical photography lens assembly according to Embodiment 3 of the present disclosure;

FIG. 6 illustrates a schematic structural diagram of an optical photography lens assembly according to Embodiment 4 of the present disclosure;

FIGS. 7A-7C respectively illustrate a longitudinal aberration curve, an astigmatic curve and a lateral color curve of the optical photography lens assembly according to Embodiment 3 and Embodiment 4 of the present disclosure;

FIG. 8 illustrates a schematic structural diagram of an optical photography lens assembly according to Embodiment 5 of the present disclosure;

FIG. 9 illustrates a schematic structural diagram of an optical photography lens assembly according to Embodiment 6 of the present disclosure;

FIGS. 10A-10C respectively illustrate a longitudinal aberration curve, an astigmatic curve and a lateral color curve of the optical photography lens assembly according to Embodiment 5 and Embodiment 6 of the present disclosure;

FIG. 11A and FIG. 11B respectively illustrate a defocus curve and a relative illumination curve of sample 1 of an optical photography lens assembly;

FIG. 12A and FIG. 12B respectively illustrate a defocus curve and a relative illumination curve of sample 2 of an optical photography lens assembly;

FIG. 13 illustrates a defocus curve of sample 3 of an optical photography lens assembly;

FIG. 14A, FIG. 14B and FIG. 14C respectively illustrate schematic diagrams of stray light positions when sample 2 of an optical photography lens assembly exceeds an upper limit of a range of values of 1.5<R6/R5<2.0 and 3.0<f3/d3s<4.2; and

FIG. 15 illustrates a schematic diagram of stray light when sample 1 of an optical photography lens assembly satisfies a range of values of 1.5<R6/R5<2.0 and 3.0<f3/d3s<4.2.

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. The surface of each lens closest to the photographed object is referred to as the object side of the lens, and the surface of each lens closest to the imaging surface is referred to as the image side of the lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. Furthermore, when an expression such as “at least one of . . . ” appears before a list of features, it modifies the entire list of features, rather than individual elements within the list. In addition, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The following embodiments illustrate only several implementations of the present disclosure, and their descriptions are more specific and detailed, but they are not to be construed as a limitation to the scope of patent of the present disclosure. It should be noted that, for those of ordinary skill in the art, without departing from the concept of the present disclosure, a number of modifications and improvements can be made, which all fall within the scope of protection of the present disclosure. For example, the lens group (i.e., the first lens to the sixth lens), the lens barrel structure, and the spacing element in the various embodiments of the present disclosure may be combined arbitrarily, and the lens group in an embodiment is not limited to being combined with only the lens barrel structure, the spacing element, and the like of the embodiment.

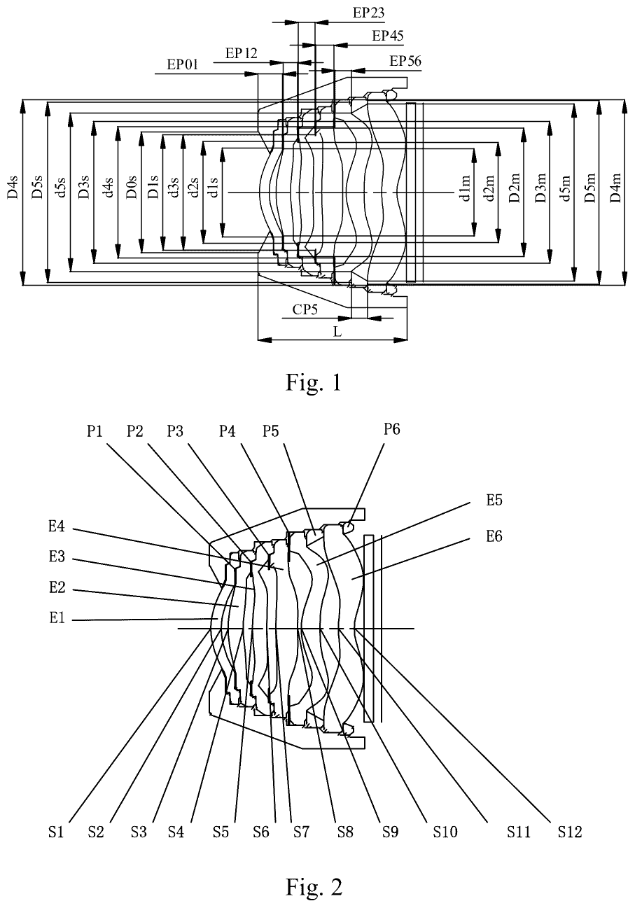

The present disclosure will be described below in detail with reference to the accompanying drawings and in combination with the embodiments. FIG. 1 illustrates a structural layout diagram of an optical photography lens assembly according to the present disclosure and a schematic diagram of some parameters. It should be understood by those skilled in the art that some parameters (e.g., the center thickness CT1 of the first lens on the optical axis, the air spacing T12 between the first lens and the second lens on the optical axis, etc.) frequently used in the art are not shown in FIG. 1, and FIG. 1 only shows some parameters of the lens barrel and spacing element of an optical photography lens assembly according to the present disclosure by examples, for a better understanding of the present disclosure. As shown in FIG. 1, EP01 represents a spacing between a front-end surface of the lens barrel closer to an object side and an object-side surface of a first spacing element along a direction of the optical axis; EP12 represents a spacing between an image-side surface of the first spacing element and an object-side surface of a second spacing element along the direction of the optical axis; EP23 represents a spacing between an image-side surface of the second spacing element and an object-side surface of a third spacing element along the direction of the optical axis; EP45 represents a spacing between an image-side surface of a fourth spacing element and an object-side surface of a fifth spacing element along the direction of the optical axis; CP5 represents a maximal thickness of the fifth spacing element along the direction of the optical axis; D0s represents an outer diameter of the front-end surface of the lens barrel closest to the object-side surface; D1s represents an outer diameter of an object-side surface of the first spacing element; d1s represents an inner diameter of the object-side surface of the first spacing element; D1m represents an outer diameter of an image-side surface of the first spacing element; d1m represents an inner diameter of the image-side surface of the first spacing element; D2s represents an outer diameter of an object-side surface of the second spacing element; d2s represents an inner diameter of the object-side surface of the second spacing element; D2m represents an outer diameter of an image-side surface of the second spacing element; d2m represents an inner diameter of the image-side surface of the second spacing element; and so on.

Features, principles and other aspects of the present disclosure will be described in detail below.

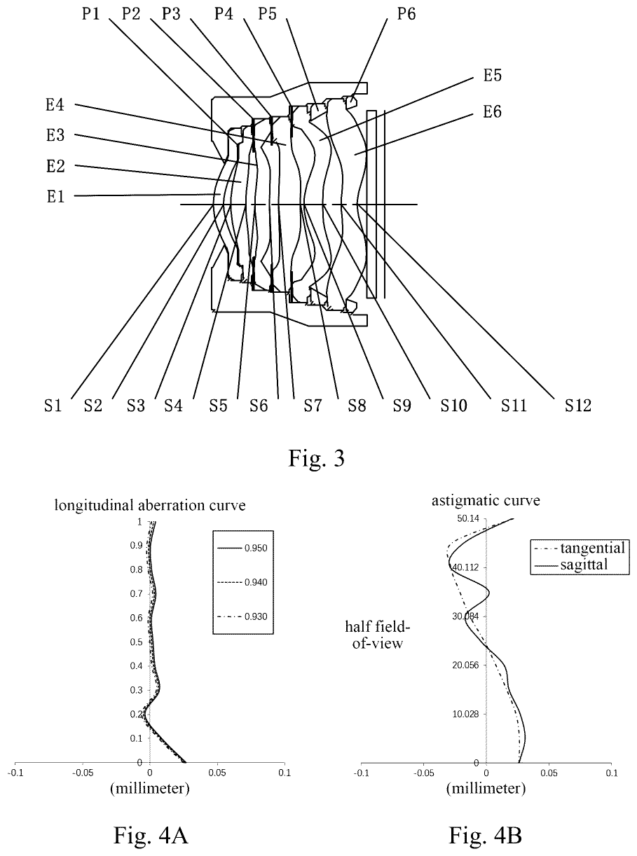

With reference to FIG. 2 and FIG. 3, a first aspect of the present disclosure provides an optical photography lens assembly, which may include a lens barrel, a lens group, and at least one spacing element, the lens group as well as the one or more spacing elements being accommodated within the lens barrel. The lens group may include six lenses having refractive powers, which are respectively: a first lens, a second lens, a third lens, a fourth lens, a fifth lens, and a sixth lens, disposed sequentially from an object side to an image side along a direction of an optical axis. Here, there may be a spacing distance between any two adjacent lenses in the first lens to the sixth lens.

In the exemplary implementations, the first lens may have a negative refractive power. The second lens may have a positive refractive power. The third lens may have a positive refractive power. The fourth lens may have a negative refractive power. The fifth lens may have a positive refractive power. The sixth lens may have a negative refractive power.

In the exemplary implementations, the lens group may have at least one edged lens. An outer peripheral surface of the edged lens may have an edged portion and an unedged portion, and an outer diameter of the edged portion of the lens is smaller than an outer diameter of the unedged portion of the lens. When the outer peripheral surface of the lens has the edged portion, an outer diameter of the lens usually refers to the outer diameter of the unedged portion of the lens.

The optical photography lens assembly according to the exemplary implementations of the present disclosure includes at least one spacing element, for example, may include any one or more of the following spacing elements: a first spacing element disposed between the first lens and the second lens and in direct contact with an image side of the first lens, a second spacing element disposed between the second lens and the third lens and in direct contact with an image side of the second lens, a third spacing element disposed between the third lens and the fourth lens and in direct contact with an image side of the third lens; a fourth spacing element disposed between the fourth lens and the fifth lens and in direct contact with an image side of the fourth lens, a fifth spacing element disposed between the fifth lens and the sixth lens and in direct contact with an image side of the fifth lens, and a sixth spacing element disposed an image side of the sixth lens and in direct contact with the image side of the sixth lens, etc. Exemplarily, the spacing elements may include spacers, light-blocking plates, spacing rings, or compression rings, etc. Reasonably setting the number, thickness, inner diameter, and outer diameter of the spacing elements is conducive to blocking stray light, improving an imaging quality of the optical photography lens assembly, and can improve the assembling stability of the optical photography lens assembly.

It should be understood that a surface of each optical element (e.g., lens, spacing element) that is closest to a photographed object is referred to as the object-side surface of the optical element, and a surface of each optical element that is closest to an image plane is referred to as the image-side surface of the optical element. A surface of the lens barrel that is closest to a photographed object is referred to as an object-side end surface or a front-end surface of the lens barrel, and a surface of the lens barrel that is closest to the image plane is referred to as an image-side end surface or a rear-end surface of the lens barrel.

In the exemplary implementations, the optical photography lens assembly according to the present disclosure may satisfy the following conditional expressions: 1.5<R6/R5<2.0; and 3.2<f3/d3s<4.2, where, R5 is a radius of curvature of an object-side surface of the third lens, R6 is a radius of curvature of an image-side surface of the third lens, f3 is an effective focal length of the third lens, and d3s is an inner diameter of an object-side surface of the third spacing element. Controlling the optical photography lens assembly to satisfy the conditional expressions: 1.5<R6/R5<2.0 and 3.2<f3/d3s<4.2, is conducive to improving a field curvature of the optical structure and correcting aberrations, achieving the design of the lens assembly having small field curvature and low astigmatism as well as small aberrations, which ensures a high imaging resolution, and improves the ability of terminal electronic devices to recognize details, and enables the lens assembly to have small field curvature, low dispersion, and high relative illumination (RI), while reducing the sensitivity of the third lens and improving stray light in a structural area of the third lens, thereby improving the imaging quality.

In the exemplary implementations, the optical photography lens assembly according to the present disclosure may satisfy the following conditional expression: −75.0<R10*N5/d5s<−18.0, where, R10 is a radius of curvature of an image-side surface of the fifth lens, N5 is a refractive index of the fifth lens, and d5s is an inner diameter of an object-side surface of the fifth spacing element. Satisfying the above conditional expression, by controlling the relationship among the radius of curvature of the image-side surface of the fifth lens, the refractive index of the fifth lens and the inner diameter of the object-side surface of the fifth spacing element, the fifth lens can converge light from an inner field-of-view, improve the performance of the inner field-of-view, and diverge light from an external field-of-view to achieve the purpose of designing an image height; and is also conducive to blocking stray light generated at an effective diameter edge of the fifth lens, improving the imaging quality.

In the exemplary implementations, the optical photography lens assembly according to the present disclosure may satisfy the following conditional expression: 3.5<(EP01+CT2)/CT1<5.0, where, EP01 is a spacing between a front-end surface of the lens barrel and the first spacing element, CT1 is a center thickness of the first lens on the optical axis, and CT2 is a center thickness of the second lens on the optical axis. Satisfying the above conditional expression, by controlling the relationship among the spacing distance between the front-end surface of the lens barrel and the first spacing element and the center thicknesses of the first lens and the second lens on the optical axis, the purpose of controlling a relative position between a front end of the lens barrel and the optical system is achieved, and a total height of the lens barrel is indirectly controlled within a reasonable range, which not only avoids convexity of the optical lenses due to the total height of the lens barrel being too small, but also prevents the problem of an oversized lens assembly due to the total height of the lens barrel being too high.

In the exemplary implementations, the optical photography lens assembly according to the present disclosure may satisfy the following conditional expressions: 0.9<EP12/CT2<1.1; and 1.4<CT2/CT1≤2.3, where, CT1 is the center thickness of the first lens on the optical axis, CT2 is the center thickness of the second lens on the optical axis, and EP12 is the spacing between the first spacing element and the second spacing element. Satisfying the above conditional expressions, on the one hand, by controlling the ratio of the center thickness of the second lens to the center thickness of the first lens, a divergence angle of light at the front end of the lens group can be controlled, so as to meet design requirements for a rear end of the lens group. On the other hand, by simultaneously controlling the ratio of the spacing distance between the first spacing element and the second spacing element to the center thickness of the second lens, the relationship between the center thickness of the second lens and an edge thickness of the second lens is controlled, so as to ensure a smooth transition in an overall shape of the second lens, avoid excessive fluctuations in the thickness ratio and improve the molding stability.

In the exemplary implementations, the optical photography lens assembly according to the present disclosure may satisfy the following conditional expression: 5.5<f2*N2/d2s<6.5, where, f2 is an effective focal length of the second lens, N2 is a refractive index of the second lens, and d2s is the inner diameter of the object-side surface of the second spacing element. Satisfying the above conditional expression, by controlling the relationship among the effective focal length of the second lens and the refractive index of the second lens and the inner diameter of the object-side surface of the second spacing element, the purpose of controlling a divergence range of marginal rays is achieved, the RI of an edge field-of-view is improved, and the generation of dark corners is avoided, while meeting the design requirements for the rear end of the lens group.

In the exemplary implementations, the optical photography lens assembly according to the present disclosure may satisfy the following conditional expression: 7.0<f12/(D2m−d2m)<17.5, where, f12 is a combined focal length of the first lens and the second lens, D2m is the outer diameter of the image-side surface of the second spacing element, and d2m is the inner diameter of the image-side surface of the second spacing element. Satisfying the above conditional expression, by controlling the ratio of the combined focal length of the first lens and the second lens to the difference between the outer and inner diameters of the second spacing element, the purpose of controlling the outer diameter of the front end of the lens group is achieved, so as to avoid that the front-end size is too large and exceeds specified specifications. At the same time, chief rays incident upon and exiting the second lens may be within a reasonable angle range, thereby effectively reducing the risk of stray light.

In the exemplary implementations, the optical photography lens assembly according to the present disclosure may satisfy the following conditional expression: 1.5<(T23+CT3+T34)/EP23<2.0, where, T23 is an air spacing between the second lens and the third lens on the optical axis, T34 is an air spacing between the third lens and the fourth lens on the optical axis, CT3 is a center thickness of the third lens on the optical axis, and EP23 is the spacing between the second spacing element and the third spacing element. Satisfying the above conditional expression, by controlling the ratio of the sum of the center thickness and air spacing of the second lens and the third lens to the spacing between the second spacing element and the third spacing element, the relationship between the center thickness and edge thickness of the third lens is controlled, so as to ensure a smooth transition in an overall shape of the third lens, avoid excessive fluctuations in the thickness ratio and improve the molding stability.

In the exemplary implementations, the optical photography lens assembly according to the present disclosure may satisfy the following conditional expression: 1.5<(EP45+CP5)/CT5<2.5, where, EP45 is a spacing between the fourth spacing element and the fifth spacing element, CP5 is a maximal thickness of the fifth spacing element, and CT5 is a center thickness of the fifth lens on the optical axis. Satisfying the above conditional expression, by controlling the relationship among the spacing distance between the fourth spacing element and the fifth spacing element, the maximal thickness of the fifth spacing element and the center thickness of the fifth lens, the purpose of controlling a position of an assembly surface of the sixth lens is achieved. In particular, in order to ensure manufacturability of the fifth lens, the ratio of the spacing distance between the fourth spacing element and the fifth spacing element to the center thickness of the fifth lens needs to be close, and in this regard, an assembly distance between the fifth lens and the sixth lens needs to be controlled by the fifth spacing element, therefore, satisfying the conditional expression may ensure the manufacturability and assembly feasibility of the fifth lens and the sixth lens.

In the exemplary implementations, the optical photography lens assembly according to the present disclosure may satisfy the following conditional expression: 0.9<T56/EP56<2.1, where, T56 is an air spacing between the fifth lens and the sixth lens on the optical axis, and EP56 is a spacing between the fifth spacing element and the sixth spacing element. Satisfying the above conditional expression, by controlling the ratio of the air spacing between the fifth lens and the sixth lens to the spacing distance between the fifth spacing element and the sixth spacing element, the purpose of controlling an edge thickness of the sixth lens is achieved, which may avoid excessive edge thickness that could limit a design space for compression rings, as well as avoid welding marks caused by an overly large thickness ratio between the edge and center of the sixth lens, while preventing performance stability risks arising from an overly small thickness ratio between the edge and center of the sixth lens.

In the exemplary implementations, the optical photography lens assembly according to the present disclosure may satisfy the following conditional expression: 31.0<R1/(d1s−d1m)<33.5, where, R1 is a radius of curvature of an object-side surface of the first lens, d1s is the inner diameter of the object-side surface of the first spacing element, and d1m is the inner diameter of the image-side surface of the first spacing element. Satisfying the above conditional expression, by controlling the ratio of the radius of curvature of the object-side surface of the first lens to the diameter difference between the object-side surface and the image-side surface of the first spacing element, the purpose of controlling a shape of an inner diameter chamfer of the first spacing element is achieved, which may avoid stray light generated by reflection from the object-side surface of the first lens to the inner diameter surface of the first spacing element.

In the exemplary implementations, the optical photography lens assembly according to the present disclosure may satisfy the following conditional expression: 0.5<EP12/EP01<1.0, where, EP12 is the spacing between the first spacing element and the second spacing element, and EP01 is the spacing between the front-end surface of the lens barrel and the first spacing element. Satisfying the above conditional expression: 0.5<EP12/EP01<1.0, by controlling the ratio of the spacing distance between the first spacing element and the second spacing element to the spacing distance between the front-end surface of the lens barrel and the first spacing element, edge assembly thicknesses of the first lens and the second lens are controlled as a whole based on satisfying the conditional expression: 3.5<(EP01+CT2)/CT1<5.0, so that thickness transition of the front end of the lens group is more uniform, and the molding stability is improved.

In the exemplary implementations, the optical photography lens assembly according to the present disclosure may satisfy the following conditional expression: 1.5<D4s/R7+D4m/R8≤2.5, where R7 is a radius of curvature of an object-side surface of the fourth lens, R8 is a radius of curvature of an image-side surface of the fourth lens, D4s is an outer diameter of an object-side surface of the fourth spacing element, and D4m is an outer diameter of an image-side surface of the fourth spacing element. Satisfying the above conditional expression, by controlling the relationship among the radii of curvature of the object-side surface and the image-side surface of the fourth lens and the outer diameters of the object-side surface and the image-side surface of the fourth spacing element, the design requirements for the rear end of the lens group may be met, while also achieving the purpose of limiting the outer diameters of the fourth lens and the fifth lens, then indirectly limiting the size of a waist portion of the lens assembly, contributing to miniaturization of the lens assembly. In addition, while controlling an overall shape of the fourth lens, adjusting the direction of light can ensure admitted light of the optical system, thereby controlling the generation of stray light of the fourth lens incident at different wavelengths.

In the exemplary implementations, the optical photography lens assembly according to the present disclosure may satisfy the following conditional expression: 0.4<R9*N5/D5s<0.6, where, R9 is a radius of curvature of an object-side surface of the fifth lens, N5 is a refractive index of the fifth lens, and D5s is an outer diameter of the object-side surface of the fifth spacing element. Satisfying the above conditional expression, by controlling the relationship among the radius of curvature of the object-side surface of the fifth lens, the refractive index of the fifth lens and the outer diameter of the object-side surface of the fifth spacing element, the purpose of controlling the shape and the outer diameter of the fifth lens is achieved, which may avoid excessive distortion of the shape of the fifth lens that could affect the molding stability.

In the exemplary implementations, the optical photography lens assembly according to the present disclosure may satisfy the following conditional expression: −3.5<f6/d5m<−0.9, where, f6 is an effective focal length of the sixth lens, and d5m is an inner diameter of an image-side surface of the fifth spacing element. Satisfying the above conditional expression, by controlling the ratio of the effective focal length of the sixth lens to the inner diameter of the image-side surface of the fifth spacing element, the purpose of controlling a range of marginal rays of the sixth lens is achieved, which may prevent the generation of stray light while ensuring optical parameters, thereby ensuring an image quality of the image plane.

In the exemplary implementations, the optical photography lens assembly according to the present disclosure may satisfy the following conditional expression: 1.6<L/ΣCT<1.8, where, L is a maximal height of the lens barrel along the direction of the optical axis, and ΣCT is a sum of center thicknesses of all lenses in the lens group on the optical axis. Satisfying the above conditional expression, by controlling the ratio relationship between the maximal height of the lens barrel and the sum of the center thicknesses of all the lenses on the optical axis, a position of a rear-end surface of the lens barrel is limited, based on having limited the front-end surface of the lens barrel by satisfying the conditional expression: 3.5<(EP01+CT2)/CT1<5.0, thus, a total length of the lens barrel is controlled to adapt to the assembly of components at the rear end.

In the exemplary implementations, the optical photography lens assembly according to the present disclosure may satisfy the following conditional expression: 1.7<D3s/R5+D3m/R6<2.9, where, D3s is an outer diameter of the object-side surface of the third spacing element, R5 is the radius of curvature of the object-side surface of the third lens, R6 is the radius of curvature of the image-side surface of the third lens, and D3m is an outer diameter of an image-side surface of the third spacing element. Satisfying the above conditional expression, by controlling the relationship among the outer diameters of the object-side surface and the image-side surface of the third spacing element and the radii of curvature of the object-side surface and the image-side surface of the third lens, the purpose of limiting the shape and the outer diameters of the third spacing element is achieved. In addition, by simultaneously satisfying the conditional expressions: 1.7<D3s/R5+D3m/R6<2.9 and 7.0<f12/(D2m−d2m)<17.5, the function of controlling diameters of front-end lenses can be jointly achieved, preventing a front end size of the lens assembly from being too large.

In the exemplary implementations, the optical photography lens assembly according to the present disclosure may satisfy the following conditional expression: 2.0<f45/(D4s-d4s)<6.5, where, f45 is a combined focal length of the fourth lens and the fifth lens, D4s is the outer diameter of the object-side surface of the fourth spacing element, and d4s is an inner diameter of the object-side surface of the fourth spacing element. Satisfying the above conditional expression, by controlling the ratio of the combined focal length of the fourth lens and the fifth lens to the difference between the outer diameter and the inner diameter of the object-side surface of the fourth spacing element, the purpose of controlling the outer diameters of the fourth lens and the fifth lens is achieved. In addition, by simultaneously satisfying the conditional expressions: 2.0<f45/(D4s−d4s)<6.5 and 1.5<D4s/R7+D4m/R8<2.5, dimensions of the waist portion and rear end of the lens assembly are jointly limited, which enables a more uniform dimension change in the inner diameter of the rear end of the lens barrel, ensures the assembly stability of the lens assembly, and contributes to the miniaturization of the lens assembly.

In the exemplary implementations, the optical photography lens assembly according to the present disclosure may satisfy the following conditional expression: 0.8<f56/D5m<2.4, where, f56 is a combined focal length of the fifth lens and the sixth lens, and D5m is an outer diameter of the image-side surface of the fifth spacing element. Satisfying the above conditional expression, by controlling the ratio of the combined focal length of the fifth lens and the sixth lens to the outer diameter of the image-side surface of the fifth spacing element, the purpose of controlling the outer diameter of the sixth lens is achieved, indirectly achieving the purpose of controlling the diameter of the rear end of the lens assembly, and contributing to the miniaturization of the lens assembly. At the same time, the purpose of controlling a gradient transition in the outer diameters between the fifth lens and the sixth lens within the lens barrel is achieved, improving the assembly stability of the lens assembly.

In the exemplary implementations, the optical photography lens assembly according to the present disclosure may satisfy the following conditional expression: 1.1<f5/R10+f5/d5s<3.0, where, f5 is an effective focal length of the fifth lens, R10 is the radius of curvature of the image-side surface of the fifth lens, and d5s is the inner diameter of the object-side surface of the fifth spacing element. Satisfying the above conditional expression, by controlling the relationship among the effective focal length of the fifth lens, the radius of curvature of the image-side surface of the fifth lens and the inner diameter of the object-side surface of the fifth spacing element, the purpose of controlling the overall shape of the fifth lens is achieved, while meeting a RI design requirement for the external field-of-view, the range of marginal rays is controlled, so as to prevent the generation of stray light.

A second aspect of the present disclosure provides an optical photography lens assembly, which may include a lens barrel, a lens group, and at least one spacing element, the lens group as well as the one or more spacing elements being accommodated within the lens barrel. The lens group may include six lenses having refractive powers, which are respectively: a first lens, a second lens, a third lens, a fourth lens, a fifth lens, and a sixth lens, disposed sequentially from an object side to an image side along a direction of an optical axis. Here, the first lens, the fourth lens and the sixth lens may have negative refractive powers, and the second lens, the third lens and the fifth lens may have positive refractive powers. The at least one spacing element may, for example, include a second spacing element disposed between the second lens and the third lens, the second spacing element may be in contact with a non-optical area of an image-side surface of the second lens. Exemplarily, the second spacing element may be against the non-optical area of the image-side surface of the second lens.

In the exemplary implementations, the optical photography lens assembly according to the present disclosure may satisfy the following conditional expressions: 0.9<EP12/CT2<1.1; and 1.4<CT2/CT1≤2.3, where, CT1 is a center thickness of the first lens on the optical axis, CT2 is a center thickness of the second lens on the optical axis, and EP12 is a spacing between a first spacing element and the second spacing element. Satisfying the above conditional expressions, on the one hand, by controlling the ratio of the center thickness of the second lens to the center thickness of the first lens, a divergence angle of light at a front end of the lens group can be controlled, so as to meet design requirements for a rear end of the lens group. On the other hand, by simultaneously controlling the ratio of the spacing distance between the first spacing element and the second spacing element to the center thickness of the second lens, the relationship between the center thickness of the second lens and an edge thickness of the second lens is controlled, so as to ensure a smooth transition in an overall shape of the second lens, avoid excessive fluctuations in the thickness ratio and improve the molding stability.

A third aspect of the present disclosure provides an optical photography lens assembly, which may include a lens barrel, a lens group, and at least one spacing element, the lens group as well as the one or more spacing elements being accommodated within the lens barrel. The lens group may include six lenses having refractive powers, which are respectively: a first lens, a second lens, a third lens, a fourth lens, a fifth lens, and a sixth lens, disposed sequentially from an object side to an image side along a direction of an optical axis. Here, there may be a spacing distance between any two adjacent lenses in the first lens to the sixth lens. The at least one spacing element may, for example, include a fifth spacing element disposed between the fifth lens and the sixth lens, the fifth spacing element may be in contact with a non-optical area of an image-side surface of the fifth lens. Exemplarily, the fifth spacing element may be against the non-optical area of the image-side surface of the fifth lens.

In the exemplary implementations, the optical photography lens assembly according to the present disclosure may satisfy the following conditional expression: 1.1<f5/R10+f5/d5s<3.0, where, f5 is an effective focal length of the fifth lens, R10 is a radius of curvature of the image-side surface of the fifth lens, and d5s is an inner diameter of an object-side surface of the fifth spacing element. Satisfying the above conditional expression, by controlling the relationship among the effective focal length of the fifth lens, the radius of curvature of the image-side surface of the fifth lens and the inner diameter of the object-side surface of the fifth spacing element, the purpose of controlling an overall shape of the fifth lens is achieved, while meeting a RI design requirement for an external field-of-view, a range of marginal rays is controlled, so as to prevent the generation of stray light.

It should be understood that the number of the spacing elements is not specifically limited in the present disclosure, any number of spacing elements may be included between any two lenses, and the entire optical photography lens assembly may also include any number of spacing elements. The spacing elements help the optical photography lens assembly to intercept unwanted refraction and reflection optical paths, thereby reducing the generation of stray light and ghost images. The addition of auxiliary bearing between the spacing elements and the lens barrel is conducive to improving the problems of poor assembling stability and low performance yield caused by the large mismatch between the lenses.

In some implementations, the optical photography lens assembly according to the present disclosure may further include an optical filter and/or a protective glass provided between the sixth lens and the image plane for filtering light having different wavelengths, correcting colour deviations, and protecting a photosensitive element on the image plane.

In some implementations, the optical photography lens assembly according to the present disclosure may further include a diaphragm provided between the object side and the first lens. The provision of the diaphragm is conducive to effectively converging light entering the lens assembly, and to reducing the diameters of the lenses.

The optical photography lens assembly according to the above implementations of the present disclosure may use a plurality of lenses for its lens group, for example, the six lenses described above. By reasonably distributing the focal lengths and surface types of the lenses, the center thicknesses of the lenses, and the axial spacing distances between the lenses, etc., incident light can be effectively converged, a total track length can be reduced and the processibility can be improved, which is more conducive to production and processing of the optical photography lens assembly.

In the implementations of the present disclosure, at least one of the surfaces of the lenses in the first lens to the sixth lens is an aspheric surface. An aspheric lens is characterized in that the curvature continuously changes from the center of the lens to the periphery. Different from a spherical lens having a constant curvature from the center of the lens to the periphery, the aspheric lens has a better radius-of-curvature characteristic, and has advantages of improving a distortion aberration and an astigmatic aberration. The use of the aspheric lens can eliminate as much as possible the aberrations that occur during the imaging, thereby improving the imaging quality. Alternatively, the object-side surface and image-side surface of each of the first lens to the sixth lens are aspheric surfaces.

Embodiments 1-6 of the optical photography lens assembly that may be applicable to the above exemplary implementations are further described below with reference to the accompanying drawings.

### Embodiment 1

An optical photography lens assembly according to Embodiment 1 of the present disclosure is described below with reference to FIG. 2.

As shown in FIG. 2, the optical photography lens assembly includes a lens barrel as well as a lens group and at least one spacing element accommodated within the lens barrel.

The lens group from an object side to an image side sequentially includes: a first lens E1, a second lens E2, a third lens E3, a fourth lens E4, a fifth lens E5, and a sixth lens E6.

The at least one spacing element includes: a first spacing element P1, a second spacing element P2, a third spacing element P3, a fourth spacing element P4, a fifth spacing element P5, and a sixth spacing element P6. The spacing element may block stray light from entering into a next lens during imaging, while also enabling a better support between the lens and the lens barrel, thereby enhancing the structural stability of the optical photography lens assembly.

Exemplarily, each spacing element may include at least one spacer, e.g., any one in the first spacing element P1 to the fourth spacing element P4 may include a spacer; or each spacing element may include a spacing ring, e.g., the fifth spacing element P5 or the sixth spacing element P6 may include a spacing ring.

The first lens E1 has a positive refractive power, an object-side surface S1 of the first lens E1 is a convex surface, and an image-side surface S2 of the first lens E1 is a concave surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a concave surface. The fourth lens E4 has a negative refractive power, an object-side surface S7 of the fourth lens E4 is a convex surface, and an image-side surface S8 of the fourth lens E4 is a concave surface. The fifth lens E5 has a positive refractive power, an object-side surface S9 of the fifth lens E5 is a convex surface, and an image-side surface S10 of the fifth lens E5 is a convex surface. The sixth lens E6 has a negative refractive power, an object-side surface S11 of the sixth lens E6 is a convex surface, and an image-side surface S12 of the sixth lens E6 is a concave surface. The optical photography lens assembly further includes an optical filter (not shown) disposed between the sixth lens E6 and an image plane S15. The optical filter has an object-side surface S13 (not shown) and an image-side surface S14 (not shown). Light from an object sequentially passes through the surfaces S1-S14 and finally forms an image on the image plane S15.

Table 1 shows a table of basic parameters of the optical photography lens assembly in Embodiment 1. Here, the units of a radius of curvature, a thickness/distance and an effective focal length are millimeters (mm).

TABLE 1

| | | radius | | material | | |
|---|---|---|---|---|---|---|
| | | of | thick- | refrac- | | conic |
| surface | surface | curva- | ness/ | tive | abbe | coeffi- |
| number | type | ture | distance | index | number | cient |
| OBJ | spherical | infinite | 600.0000 | | | |
| STO | spherical | infinite | −0.2463 | | | |
| S1 | aspheric | 1.3794 | 0.2292 | 1.653 | 20.6 | −2.6247 |
| S2 | aspheric | 1.2557 | 0.1567 | | | −0.7501 |
| S3 | aspheric | 1.9706 | 0.3374 | 1.670 | 19.3 | −0.0170 |
| S4 | aspheric | 2.8013 | 0.2019 | | | 0.8643 |
| S5 | aspheric | 2.8225 | 0.3192 | 1.671 | 19.2 | 0.3934 |
| S6 | aspheric | 5.1146 | 0.2004 | | | 4.0356 |
| S7 | aspheric | 5.1310 | 0.4847 | 1.671 | 19.2 | −0.2079 |
| S8 | aspheric | 4.5572 | 0.0843 | | | −98.6319 |
| S9 | aspheric | 1.3472 | 0.4163 | 1.668 | 19.5 | −8.0328 |
| S10 | aspheric | 5.8713 | 0.4098 | | | −42.8920 |
| S11 | aspheric | 1.7076 | 0.3549 | 1.572 | 38.2 | −4.3135 |
| S12 | aspheric | 0.8822 | 0.2160 | | | −0.9450 |
| S13 | spherical | infinite | 0.2100 | 1.535 | 55.8 | |
| S14 | spherical | infinite | 0.1852 | | | |
| S15 | spherical | infinite | | | | |

In Embodiment 1, the object-side surface and the image-side surface of any lens in the first to sixth lenses E1-E6 are both aspheric surfaces, and the surface type x of each aspheric lens may be defined using, but not limited to, the following aspheric formula:

$$x = \frac{{ch}^{2}}{1 + \sqrt{1 - ( k + 1 ) {c}^{2} {h}^{2}}} + \sum {Aih}^{i} \qquad ( 1 )$$

Here, x is the sag-the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Tables 2-1 and 2-2 below give the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 1.

TABLE 2-1

| surface number | A4 | A6 | A8 | A10 | A12 | A14 | A16 |
|---|---|---|---|---|---|---|---|
| S1 | 1.3605E−02 | −4.4521E−03 | 2.2756E−04 | −1.6683E−04 | −2.9343E−05 | −7.1438E−05 | 1.8089E−05 |
| S2 | −8.3667E−02 | 1.7725E−03 | −6.4574E−04 | 4.2784E−04 | −2.4663E−04 | 9.0613E−05 | −5.8554E−05 |
| S3 | −1.0416E−01 | 2.0705E−03 | 3.2615E−04 | 1.1174E−03 | 3.1487E−04 | 3.8537E−04 | 2.1727E−04 |
| S4 | −1.6688E−01 | 9.1292E−03 | 1.4423E−03 | −8.8428E−04 | −1.1850E−03 | 4.3845E−04 | 7.4026E−04 |
| S5 | −2.7874E−01 | 2.1754E−02 | 1.3288E−02 | −2.1153E−03 | −4.6923E−03 | −6.5927E−04 | −2.7273E−05 |
| S6 | −3.4993E−01 | 1.7385E−03 | 1.1491E−02 | 3.4320E−03 | −1.1288E−03 | 3.1164E−04 | −1.0031E−03 |
| S7 | −1.9232E−01 | 1.1745E−02 | −1.6093E−02 | −5.8331E−03 | −1.2839E−03 | 2.9951E−03 | 1.0822E−03 |
| S8 | −4.3986E−01 | 1.5918E−01 | −2.6119E−02 | −8.7909E−03 | −9.3083E−04 | 2.0176E−03 | 1.1110E−03 |
| S9 | −4.6105E−01 | −1.0198E−01 | 7.3090E−02 | −7.7614E−03 | 1.7111E−03 | −3.0526E−03 | −7.6027E−04 |
| S10 | −2.3861E−01 | −2.6253E−01 | 7.6503E−02 | −1.6136E−02 | 1.4001E−02 | 2.2061E−03 | −2.0244E−03 |
| S11 | −1.3248E+00 | 4.5393E−01 | −1.4669E−01 | 4.5825E−02 | −9.7261E−03 | 2.0890E−03 | −3.2976E−03 |
| S12 | −3.3148E+00 | 5.6432E−01 | −1.5811E−01 | 3.9437E−02 | −2.8693E−02 | 1.5547E−02 | −2.1480E−03 |

TABLE 2-2

| surface number | A18 | A20 | A22 | A24 | A26 | A28 | A30 |
|---|---|---|---|---|---|---|---|
| S1 | −3.2699E−05 | 7.1438E−05 | −7.4976E−06 | 5.3483E−05 | 2.4589E−05 | 1.7932E−05 | 1.3880E−05 |
| S2 | 4.8139E−05 | −2.6809E−05 | 2.2676E−06 | 5.0794E−05 | 1.2556E−05 | 2.0679E−05 | 4.2594E−05 |
| S3 | 8.3677E−05 | −5.8718E−05 | −8.9276E−05 | −6.6224E−05 | −3.3664E−05 | 3.2273E−06 | 1.0251E−05 |
| S4 | 5.7888E−04 | 2.1757E−04 | 5.1761E−05 | −5.4135E−06 | 5.8824E−06 | −1.4791E−05 | −3.6348E−06 |
| S5 | 3.9418E−05 | −1.3644E−04 | 2.6332E−05 | 1.2212E−05 | 2.7115E−05 | −1.7088E−05 | 4.8288E−06 |
| S6 | −8.4967E−04 | −6.4036E−04 | −2.0611E−04 | −1.1449E−04 | 7.0335E−06 | 1.4415E−05 | 3.0308E−05 |
| S7 | 2.3448E−04 | −1.3353E−04 | −1.2304E−04 | −1.6576E−04 | −2.8552E−05 | 2.2243E−05 | 4.0616E−05 |
| S8 | −2.1045E−04 | 1.0003E−04 | 1.9744E−04 | 2.4585E−05 | −5.6792E−05 | −3.7747E−05 | −2.0057E−05 |
| S9 | 1.4215E−03 | 1.1394E−03 | −3.0865E−04 | −5.0634E−04 | −1.8113E−04 | 2.6278E−05 | −4.1036E−06 |
| S10 | 9.5096E−04 | −5.4953E−04 | 2.9496E−04 | 9.7208E−05 | −1.2588E−05 | −1.1354E−04 | −1.0723E−04 |
| S11 | 1.8032E−04 | −2.3614E−04 | 1.3403E−04 | 7.9587E−05 | 1.3456E−05 | −5.1883E−06 | −2.7579E−06 |
| S12 | 7.8489E−04 | −1.9422E−03 | 2.6110E−04 | 9.9182E−06 | 2.2791E−05 | −1.8676E−05 | 1.5700E−05 |

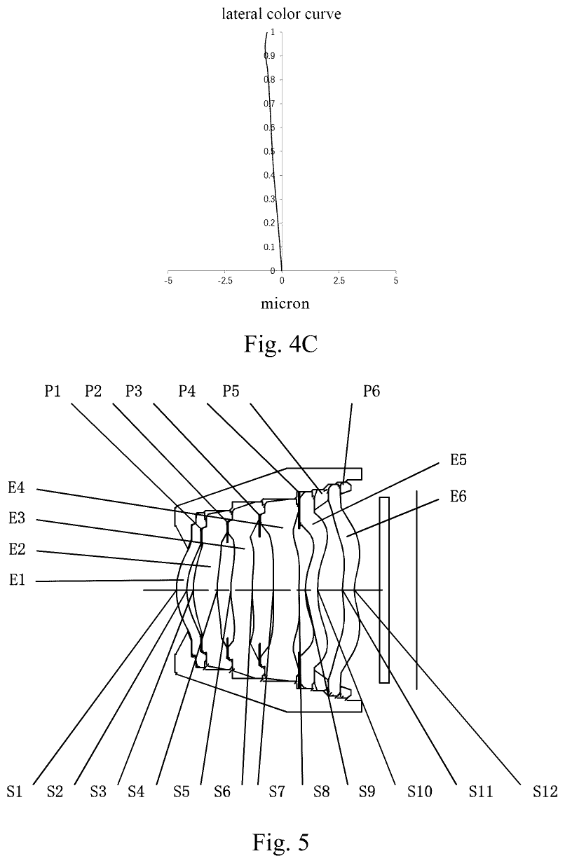

FIG. 4A illustrates a longitudinal aberration curve of the optical photography lens assembly in Embodiment 1, representing deviations of focal points at which lights of different wavelengths passing through the lens assembly converge. FIG. 4B illustrates an astigmatic curve of the optical photography lens assembly in Embodiment 1, representing a curvature of a tangential image plane and a curvature of a sagittal image plane. FIG. 4C illustrates a lateral color curve of the optical photography lens assembly in Embodiment 1, representing deviations of different image heights on the image plane formed by light passing through the lens assembly. It can be seen from FIGS. 4A-4C that the optical photography lens assembly given in Embodiment 1 can achieve a good imaging quality.

### Embodiment 2

An optical photography lens assembly according to Embodiment 2 of the present disclosure is described below with reference to FIG. 3. In this embodiment and the following embodiments, for the sake of brevity, some descriptions similar to those in Embodiment 1 will be omitted.

As shown in FIG. 3, the optical photography lens assembly includes a lens barrel as well as a lens group and at least one spacing element accommodated within the lens barrel. The lens group from an object side to an image side sequentially includes: a first lens E1, a second lens E2, a third lens E3, a fourth lens E4, a fifth lens E5, and a sixth lens E6. The spacing element includes: a first spacing element P1, a second spacing element P2, a third spacing element P3, a fourth spacing element P4, a fifth spacing element P5, and a sixth spacing element P6.

Parameters such as the radius of curvature, the center thickness, and the spacing between lenses and the high-order coefficients in the first lens to the sixth lens in the optical photography lens assembly of this embodiment are the same as those in Embodiment 1, as shown in Tables 1, 2-1, and 2-2. In addition, the number of spacing elements included in the optical photography lens assembly of this embodiment is the same as that in Embodiment 1. The only difference lies in the actual parameters of the lens barrel and each spacing element, for example, at least one of the parameters such as the size of the lens barrel, the thickness of the spacing element, the inner diameter and outer diameter of the spacing element, and the spacing distance between the spacing elements is different. In other words, the main structure for imaging is the same, while an auxiliary structure for imaging is different. Therefore, the imaging quality of the optical photography lens assembly in Embodiment 2 of the present disclosure is as shown in FIGS. 4A-4C.

### Embodiment 3

An optical photography lens assembly according to Embodiment 3 of the present disclosure is described below with reference to FIG. 5.

As shown in FIG. 5, the optical photography lens assembly includes a lens barrel as well as a lens group and at least one spacing element accommodated within the lens barrel. The lens group from an object side to an image side sequentially includes: a first lens E1, a second lens E2, a third lens E3, a fourth lens E4, a fifth lens E5, and a sixth lens E6. The spacing element includes: a first spacing element P1, a second spacing element P2, a third spacing element P3, a fourth spacing element P4, a fifth spacing element P5, and a sixth spacing element P6.

The first lens E1 has a positive refractive power, an object-side surface S1 of the first lens E1 is a convex surface, and an image-side surface S2 of the first lens E1 is a concave surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a concave surface. The fourth lens E4 has a negative refractive power, an object-side surface S7 of the fourth lens E4 is a convex surface, and an image-side surface S8 of the fourth lens E4 is a concave surface. The fifth lens E5 has a positive refractive power, an object-side surface S9 of the fifth lens E5 is a convex surface, and an image-side surface S10 of the fifth lens E5 is a convex surface. The sixth lens E6 has a negative refractive power, an object-side surface S11 of the sixth lens E6 is a convex surface, and an image-side surface S12 of the sixth lens E6 is a concave surface. The optical photography lens assembly further includes an optical filter (not shown) disposed between the sixth lens E6 and an image plane S15.

Table 3 shows a table of basic parameters of the optical photography lens assembly in Embodiment 3. Here, the units of a radius of curvature, a thickness/distance and an effective focal length are millimeters (mm).

TABLE 3

| | | radius | | material | | |
|---|---|---|---|---|---|---|
| | | of | thick- | refrac- | | conic |
| surface | surface | curva- | ness/ | tive | abbe | coeffi- |
| number | type | ture | distance | index | number | cient |
| OBJ | spherical | infinite | 600.0000 | | | |
| STO | spherical | infinite | −0.2463 | | | |
| S1 | aspheric | 1.4548 | 0.2284 | 1.547 | 53.1 | −2.4189 |
| S2 | aspheric | 1.2823 | 0.1420 | | | −0.7816 |
| S3 | aspheric | 1.8149 | 0.5252 | 1.642 | 22.9 | 0.0586 |
| S4 | aspheric | 2.5423 | 0.2990 | | | 0.8421 |
| S5 | aspheric | 2.2440 | 0.4685 | 1.537 | 55.9 | −0.3012 |
| S6 | aspheric | 3.6506 | 0.4623 | | | 5.0000 |
| S7 | aspheric | 8.4080 | 0.5646 | 1.596 | 31.0 | −46.4444 |
| S8 | aspheric | 3.8599 | 0.1425 | | | −37.3101 |
| S9 | aspheric | 1.4397 | 0.2716 | 1.639 | 22.1 | −11.8134 |
| S10 | aspheric | 2.7420 | 0.5447 | | | −57.6195 |
| S11 | aspheric | 1.5542 | 0.2628 | 1.535 | 55.8 | −3.1921 |
| S12 | aspheric | 0.9765 | 0.5551 | | | −0.9110 |
| S13 | spherical | infinite | 0.2100 | 1.535 | 55.8 | |
| S14 | spherical | infinite | 0.6024 | | | |
| S15 | spherical | infinite | | | | |

In Embodiment 3, the object-side surface and the image-side surface of any lens in the first to sixth lenses E1-E6 are both aspheric surfaces, and the surface type x of each aspheric lens may be defined using the formula (1) given in the above Embodiment 1. Tables 4-1 and 4-2 give the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 3.

TABLE 4-1

| surface number | A4 | A6 | A8 | A10 | A12 | A14 | A16 |
|---|---|---|---|---|---|---|---|
| S1 | 1.6170E−02 | −2.1241E−03 | −3.5802E−04 | 5.2073E−05 | −2.3309E−05 | 3.5099E−06 | −6.8582E−07 |
| S2 | −7.7642E−02 | −6.2565E−04 | −9.4797E−04 | 4.9943E−04 | 1.8637E−05 | 3.4840E−05 | −2.2734E−05 |
| S3 | −9.2707E−02 | 1.7114E−03 | 4.1590E−05 | 8.1269E−04 | 1.2446E−04 | 8.8510E−06 | −6.1600E−05 |
| S4 | −1.4388E−01 | 7.0718E−03 | 1.2640E−03 | 1.1756E−03 | 7.4200E−05 | −7.0329E−05 | −1.2665E−04 |
| S5 | −2.3306E−01 | 5.6188E−03 | 5.2028E−03 | 2.4815E−03 | −3.8868E−05 | −3.3847E−04 | −2.7137E−04 |
| S6 | −2.6599E−01 | 2.4027E−03 | 3.7097E−03 | 1.6213E−03 | −2.0480E−04 | −8.5022E−05 | −1.0005E−04 |
| S7 | −1.6972E−01 | 1.6766E−02 | −2.3404E−03 | −2.9890E−04 | −1.3817E−03 | −3.6781E−04 | −6.7136E−05 |
| S8 | −3.4259E−01 | 9.2713E−02 | −7.1229E−03 | 1.8390E−03 | −1.2398E−03 | −5.3514E−04 | −2.7547E−06 |
| S9 | −2.8363E−01 | −1.1088E−01 | 3.4395E−02 | −5.7567E−03 | 2.8551E−03 | 2.1319E−04 | 1.8255E−04 |
| S10 | 1.0996E−02 | −1.8596E−01 | 5.8514E−02 | −2.3669E−02 | 6.2459E−03 | −1.3467E−04 | 2.3709E−04 |
| S11 | −1.0922E+00 | 3.1240E−01 | −9.2670E−02 | 2.5297E−02 | −9.7801E−03 | 3.3313E−03 | −5.2671E−04 |
| S12 | −2.4205E+00 | 4.2898E−01 | −1.0141E−01 | 3.8551E−02 | −1.8789E−02 | 5.0801E−03 | −2.2455E−03 |

TABLE 4-2

| surface number | A18 | A20 | A22 | A24 | A26 | A28 | A30 |
|---|---|---|---|---|---|---|---|
| S1 | −1.7033E−06 | −1.4070E−06 | −1.5271E−06 | −1.1857E−06 | −1.1220E−06 | −5.7658E−07 | −3.4728E−07 |
| S2 | −2.4303E−05 | −1.3713E−05 | −4.8652E−06 | −3.8412E−07 | 4.6424E−07 | 4.4707E−07 | −6.2720E−08 |
| S3 | −4.6630E−05 | −1.6590E−05 | 1.6872E−06 | 6.7959E−06 | 5.4476E−06 | 2.9461E−06 | 9.5808E−07 |
| S4 | −7.0381E−05 | −2.5767E−05 | −4.7851E−06 | 7.3640E−07 | 1.6788E−06 | 8.6432E−07 | 3.6174E−07 |
| S5 | −9.3265E−05 | −1.8384E−06 | 1.0200E−05 | −1.0141E−06 | −5.6577E−06 | −3.8495E−06 | −9.1241E−07 |
| S6 | −2.7785E−05 | 1.1987E−05 | 1.5241E−05 | 5.4732E−06 | 1.9284E−06 | 1.9528E−07 | 3.6411E−07 |
| S7 | 8.9414E−06 | 2.9354E−05 | 4.0261E−05 | 1.9673E−05 | 8.3498E−06 | 2.5055E−06 | 1.7065E−06 |
| S8 | 4.1105E−05 | −2.9664E−05 | 4.9637E−05 | −1.1364E−05 | 5.6918E−07 | −1.1202E−05 | −9.0653E−08 |
| S9 | −7.6471E−06 | −2.7685E−04 | −6.3898E−05 | 1.6611E−05 | 3.1550E−05 | 9.8893E−06 | 8.1372E−06 |
| S10 | 3.0996E−04 | −2.8255E−04 | 2.3605E−04 | 7.6206E−05 | 4.9365E−05 | 3.3088E−05 | −1.3050E−05 |
| S11 | 8.0710E−04 | −5.4413E−04 | −7.0721E−05 | 1.6122E−04 | 7.1861E−05 | −2.1619E−05 | −2.4256E−05 |
| S12 | 1.8202E−03 | −4.6635E−04 | −1.6613E−05 | −2.1162E−04 | 5.5433E−05 | 3.1684E−05 | 2.6400E−05 |

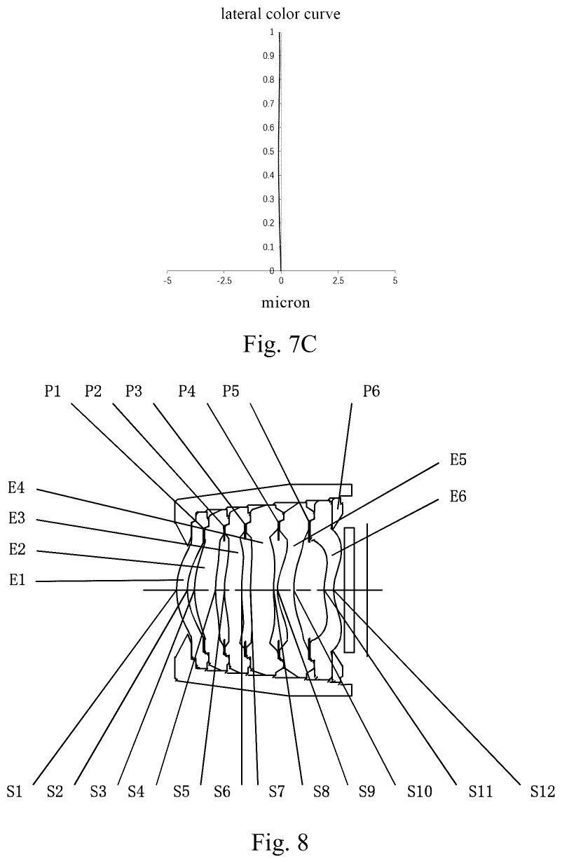

FIG. 7A illustrates a longitudinal aberration curve of the optical photography lens assembly in Embodiment 3, representing deviations of focal points at which lights of different wavelengths passing through the lens assembly converge. FIG. 7B illustrates an astigmatic curve of the optical photography lens assembly in Embodiment 3, representing a curvature of a tangential image plane and a curvature of a sagittal image plane. FIG. 7C illustrates a lateral color curve of the optical photography lens assembly in Embodiment 3, representing deviations of different image heights on the image plane formed by light passing through the lens assembly. It can be seen from FIGS. 7A-7C that the optical photography lens assembly given in Embodiment 3 can achieve a good imaging quality.

### Embodiment 4

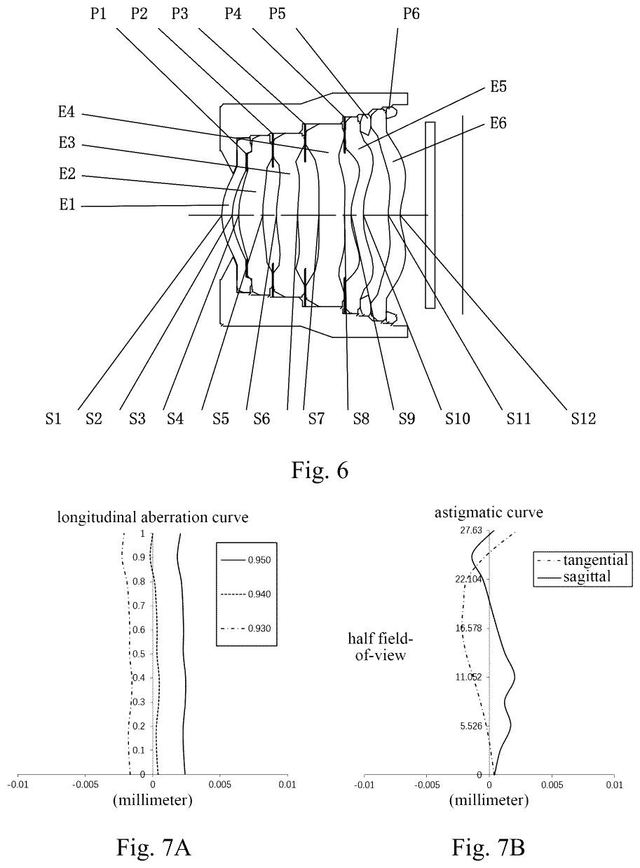

An optical photography lens assembly according to Embodiment 4 of the present disclosure is described below with reference to FIG. 6.

As shown in FIG. 6, the optical photography lens assembly includes a lens barrel as well as a lens group and at least one spacing element accommodated within the lens barrel. The lens group from an object side to an image side sequentially includes: a first lens E1, a second lens E2, a third lens E3, a fourth lens E4, a fifth lens E5, and a sixth lens E6. The spacing element includes: a first spacing element P1, a second spacing element P2, a third spacing element P3, a fourth spacing element P4, a fifth spacing element P5, and a sixth spacing element P6.

Parameters such as the radius of curvature, the center thickness, and the spacing between lenses and the high-order coefficients in the first lens to the sixth lens in the optical photography lens assembly of this embodiment are the same as those in Embodiment 3, as shown in Tables 3, 4-1, and 4-2. In addition, the number of spacing elements included in the optical photography lens assembly of this embodiment is the same as that in Embodiment 3. The only difference lies in the actual parameters of the lens barrel and each spacing element, for example, at least one of the parameters such as the size of the lens barrel, the thickness of the spacing element, the inner diameter and outer diameter of the spacing element, and the spacing distance between the spacing elements is different. In other words, the main structure for imaging is the same, while an auxiliary structure for imaging is different. Therefore, the imaging quality of the optical photography lens assembly in Embodiment 4 of the present disclosure is as shown in FIGS. 7A-7C.

### Embodiment 5

An optical photography lens assembly according to Embodiment 5 of the present disclosure is described below with reference to FIG. 8.

As shown in FIG. 8, the optical photography lens assembly includes a lens barrel as well as a lens group and at least one spacing element accommodated within the lens barrel. The lens group from an object side to an image side sequentially includes: a first lens E1, a second lens E2, a third lens E3, a fourth lens E4, a fifth lens E5, and a sixth lens E6. The spacing element includes: a first spacing element P1, a second spacing element P2, a third spacing element P3, a fourth spacing element P4, a fifth spacing element P5, and a sixth spacing element P6.

The first lens E1 has a positive refractive power, an object-side surface S1 of the first lens E1 is a convex surface, and an image-side surface S2 of the first lens E1 is a concave surface. The second lens E2 has a positive refractive power, an object-side surface S3 of the second lens E2 is a convex surface, and an image-side surface S4 of the second lens E2 is a convex surface. The third lens E3 has a negative refractive power, an object-side surface S5 of the third lens E3 is a concave surface, and an image-side surface S6 of the third lens E3 is a concave surface. The fourth lens E4 has a negative refractive power, an object-side surface S7 of the fourth lens E4 is a convex surface, and an image-side surface S8 of the fourth lens E4 is a concave surface. The fifth lens E5 has a positive refractive power, an object-side surface S9 of the fifth lens E5 is a convex surface, and an image-side surface S10 of the fifth lens E5 is a convex surface. The sixth lens E6 has a negative refractive power, an object-side surface S11 of the sixth lens E6 is a convex surface, and an image-side surface S12 of the sixth lens E6 is a concave surface.

Table 5 shows a table of basic parameters of the optical photography lens assembly in Embodiment 5. Here, the units of a radius of curvature, a thickness/distance and an effective focal length are millimeters (mm).

TABLE 5

| | | radius | | material | | |
|---|---|---|---|---|---|---|
| sur- | sur- | of | thick- | refrac- | | conic |
| face | face | curva- | ness/ | tive | abbe | coeffi- |
| number | type | ture | distance | index | number | cient |
| OBJ | spherical | infinite | 600.0000 | | | |
| STO | spherical | infinite | −0.2463 | | | |
| S1 | aspheric | 1.4100 | 0.2428 | 1.553 | 48.8 | −2.4189 |
| S2 | aspheric | 1.2250 | 0.1541 | | | −0.7816 |
| S3 | aspheric | 1.7596 | 0.4638 | 1.669 | 19.4 | 0.0586 |
| S4 | aspheric | 2.4513 | 0.1954 | | | 0.8421 |
| S5 | aspheric | 2.0992 | 0.3764 | 1.664 | 19.9 | −0.3012 |
| S6 | aspheric | 3.5524 | 0.1957 | | | 5.0000 |
| S7 | aspheric | 4.6362 | 0.5077 | 1.70 | 19.3 | −46.4444 |
| S8 | aspheric | 2.2614 | 0.0866 | | | −37.3101 |
| S9 | aspheric | 1.0586 | 0.3585 | 1.642 | 22.5 | −11.8134 |
| S10 | aspheric | 2.4196 | 0.6679 | | | −57.6195 |
| S11 | aspheric | 1.3167 | 0.2090 | 1.574 | 34.1 | −3.1921 |
| S12 | aspheric | 0.9264 | 0.2392 | | | −0.9110 |
| S13 | spherical | infinite | 0.2100 | 1.642 | 20.3 | |
| S14 | spherical | infinite | 0.2861 | | | |
| S15 | spherical | infinite | | | | |

In Embodiment 5, the object-side surface and the image-side surface of any lens in the first to sixth lenses E1-E6 are both aspheric surfaces, and the surface type x of each aspheric lens may be defined using the formula (1) given in the above Embodiment 1. Tables 6-1 and 6-2 give the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 5.

TABLE 6-1

| surface number | A4 | A6 | A8 | A10 | A12 | A14 | A16 |
|---|---|---|---|---|---|---|---|
| S1 | 1.5417E−02 | −3.8899E−03 | −6.8641E−04 | 2.2279E−04 | −1.1259E−04 | 7.3286E−05 | −3.6089E−05 |
| S2 | −9.3484E−02 | −1.3568E−04 | −5.9978E−04 | 7.0731E−04 | 3.5319E−05 | 3.9969E−05 | 3.9672E−05 |
| S3 | −1.1851E−01 | 4.1660E−03 | 1.0634E−03 | 1.2371E−03 | −7.6491E−05 | −1.6070E−05 | 1.6308E−05 |
| S4 | −1.8929E−01 | 1.4324E−02 | 2.0850E−03 | −6.9600E−04 | −1.3647E−03 | −2.6313E−04 | 2.2374E−04 |
| S5 | −2.6920E−01 | 1.3838E−02 | 9.0196E−03 | −8.1225E−04 | −2.2171E−03 | 2.0920E−04 | 1.0940E−03 |
| S6 | −3.0450E−01 | 3.4383E−03 | 9.9730E−03 | 3.6170E−04 | −1.7208E−03 | 2.2370E−04 | 1.4713E−03 |
| S7 | −1.5740E−01 | 1.5253E−02 | 6.4750E−04 | −5.5526E−04 | −2.6348E−03 | −1.9896E−04 | 9.2690E−04 |
| S8 | −3.7144E−01 | 8.2210E−02 | −8.0940E−03 | 2.3769E−03 | −2.0205E−04 | −5.3172E−04 | 9.4962E−04 |
| S9 | −1.9490E−01 | −7.9306E−02 | 2.8576E−02 | −1.6461E−02 | 6.0951E−03 | −1.5657E−03 | 6.6811E−04 |
| S10 | 8.8462E−02 | −1.8091E−01 | 6.0146E−02 | −2.0694E−02 | 4.4572E−03 | −5.3416E−03 | 2.5802E−03 |
| S11 | −1.5548E+00 | 1.2015E−01 | 1.2544E−01 | 1.9433E−02 | −2.2508E−02 | −6.3924E−03 | 1.6255E−02 |
| S12 | −2.5055E+00 | 3.2746E−01 | −3.4778E−02 | 1.6603E−02 | −5.9699E−03 | 9.2611E−03 | 5.1330E−03 |

TABLE 6-2

| surface number | A18 | A20 | A22 | A24 | A26 | A28 | A30 |
|---|---|---|---|---|---|---|---|
| S1 | 3.7826E−05 | −1.1450E−05 | 2.3337E−05 | −6.0550E−06 | 1.0842E−05 | −6.3894E−06 | 9.0878E−06 |
| S2 | 5.4523E−05 | 3.3072E−05 | 1.7229E−05 | 2.7450E−06 | −5.0891E−06 | −3.1354E−06 | −7.7124E−06 |
| S3 | 4.1073E−05 | −3.3703E−05 | −3.5631E−05 | 2.8140E−05 | 6.0722E−06 | 7.5998E−06 | 9.1946E−06 |
| S4 | 1.8954E−04 | 5.3532E−06 | −7.0382E−05 | −4.7651E−05 | −5.6513E−06 | 1.6616E−05 | 1.4374E−05 |
| S5 | 3.6872E−04 | −2.3164E−04 | −1.6573E−04 | −2.2639E−05 | 4.9358E−05 | 1.6696E−05 | 2.1760E−05 |
| S6 | 3.1030E−05 | −3.9983E−04 | −2.6221E−04 | −1.2686E−04 | −9.3600E−05 | −5.8299E−05 | −2.4038E−05 |
| S7 | −3.2981E−04 | 5.9499E−06 | 5.5937E−04 | 3.7120E−04 | 1.0955E−04 | 1.0037E−06 | 2.3139E−05 |
| S8 | −3.7295E−04 | 6.4427E−04 | 3.7571E−04 | −1.3677E−04 | −3.0039E−04 | −1.7738E−04 | −5.2172E−05 |
| S9 | −9.1087E−04 | 3.8942E−04 | −5.2680E−04 | −1.8561E−04 | 7.4215E−04 | 7.2578E−04 | 2.2793E−04 |
| S10 | 1.0267E−03 | 1.7642E−04 | 8.0466E−05 | 1.4921E−03 | 1.0717E−03 | −3.3288E−05 | −2.1582E−04 |
| S11 | 3.0684E−03 | −8.1636E−03 | −3.8226E−03 | 5.4077E−03 | 7.2656E−03 | 3.8370E−03 | 9.2034E−04 |
| S12 | −5.8875E−03 | −1.8287E−03 | 3.0045E−03 | 4.4042E−03 | 1.5486E−03 | 1.7295E−04 | −1.4708E−04 |

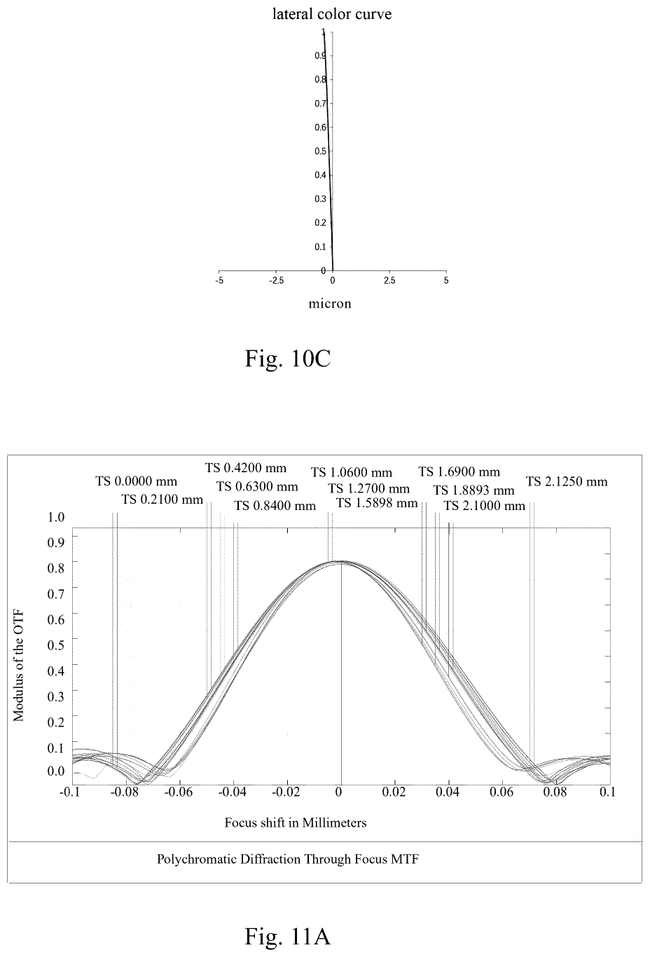

FIG. 10A illustrates a longitudinal aberration curve of the optical photography lens assembly in Embodiment 5, representing deviations of focal points at which lights of different wavelengths passing through the lens assembly converge. FIG. 10B illustrates an astigmatic curve of the optical photography lens assembly in Embodiment 5, representing a curvature of a tangential image plane and a curvature of a sagittal image plane. FIG. 10C illustrates a lateral color curve of the optical photography lens assembly in Embodiment 5, representing deviations of different image heights on the image plane formed by light passing through the lens assembly. It can be seen from FIGS. 10A-10C that the optical photography lens assembly given in Embodiment 5 can achieve a good imaging quality.

### Embodiment 6

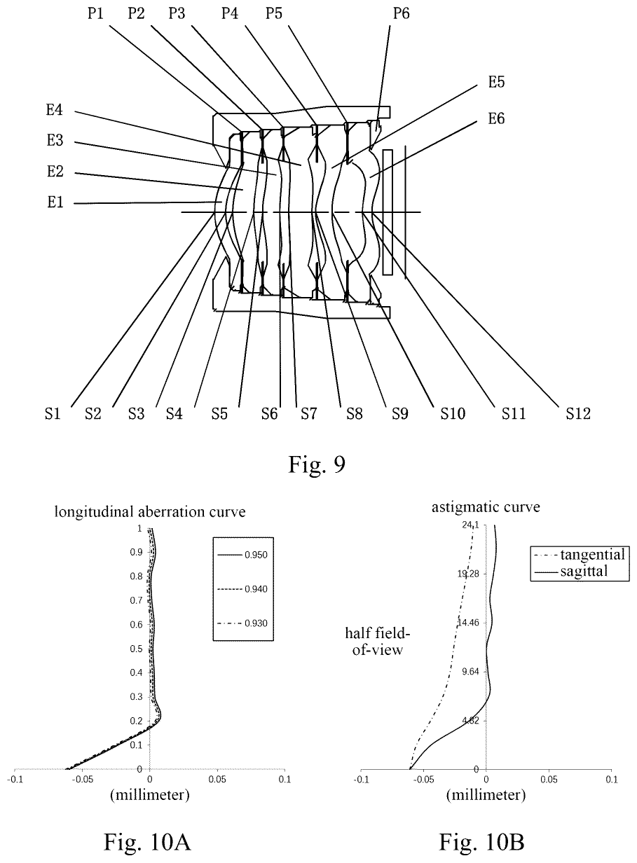

An optical photography lens assembly according to Embodiment 6 of the present disclosure is described below with reference to FIG. 9.

As shown in FIG. 9, the optical photography lens assembly includes a lens barrel as well as a lens group and at least one spacing element accommodated within the lens barrel. The lens group from an object side to an image side sequentially includes: a first lens E1, a second lens E2, a third lens E3, a fourth lens E4, a fifth lens E5, and a sixth lens E6. The spacing element includes: a first spacing element P1, a second spacing element P2, a third spacing element P3, a fourth spacing element P4, a fifth spacing element P5, and a sixth spacing element P6.

Parameters such as the radius of curvature, the center thickness, and the spacing between lenses and the high-order coefficients in the first lens to the sixth lens in the optical photography lens assembly of this embodiment are the same as those in Embodiment 5, as shown in Tables 5, 6-1, and 6-2. In addition, the number of spacing elements included in the optical photography lens assembly of this embodiment is the same as that in Embodiment 5. The only difference lies in the actual parameters of the lens barrel and each spacing element, for example, at least one of the parameters such as the size of the lens barrel, the thickness of the spacing element, the inner diameter and outer diameter of the spacing element, and the spacing distance between the spacing elements is different. In other words, the main structure for imaging is the same, while an auxiliary structure for imaging is different. Therefore, the imaging quality of the optical photography lens assembly in Embodiment 6 of the present disclosure is as shown in FIGS. 10A-10C.

Table 7 below shows some parameters of the optical photography lens assemblies in Embodiments 1-6, such as an effective focal length of each lens, and a maximal effective radius of the object-side surface or image-side surface of some lenses. Here, the units of a focal length value, a distance or an effective radius value are millimeters (mm).

TABLE 7

| parameter | | | | | | |
|---|---|---|---|---|---|---|
| value/ | | | | | | |
| embodiment | 1 | 2 | 3 | 4 | 5 | 6 |
| f1 | −78.11 | −78.11 | −37.46 | −37.46 | −32.00 | −32.00 |
| f2 | 8.94 | 8.94 | 8.04 | 8.04 | 7.72 | 7.72 |
| f3 | 9.30 | 9.30 | 9.90 | 9.90 | 7.32 | 7.32 |
| f4 | −94.80 | −94.80 | −12.92 | −12.92 | −7.51 | −7.51 |
| f5 | 2.64 | 2.64 | 4.57 | 4.57 | 2.77 | 2.77 |
| f6 | −3.86 | −3.86 | −5.93 | −5.93 | −6.92 | −6.92 |
| f12 | 10.93 | 10.93 | 11.21 | 11.21 | 11.26 | 11.26 |
| f45 | 2.82 | 2.82 | 7.38 | 7.38 | 4.77 | 4.77 |
| f56 | 4.07 | 4.07 | 9.75 | 9.75 | 3.33 | 3.33 |

Table 8 below shows some basic parameters of the lens barrels, spacing elements of the optical photography lens assemblies in Embodiments 1-6, such as d1s, d1m, D1s, d2s, d2m, D2m, EP01, EP23, EP45, EP56, CP5, and L. The units of the basic parameters listed in Table 8 are all millimeters (mm).

TABLE 8

| parameter value/ | | | | | | |
|---|---|---|---|---|---|---|
| embodiment | 1 | 2 | 3 | 4 | 5 | 6 |
| d1s (mm) | 2.031 | 2.031 | 1.960 | 1.960 | 2.086 | 2.086 |
| d1m (mm) | 1.987 | 1.987 | 1.916 | 1.916 | 2.042 | 2.042 |
| D1s (mm) | 2.631 | 2.631 | 2.673 | 2.673 | 2.686 | 3.507 |
| d2s (mm) | 2.329 | 2.329 | 2.124 | 2.124 | 2.190 | 2.190 |
| d2m (mm) | 2.285 | 2.285 | 2.080 | 2.080 | 2.146 | 2.146 |
| D2m (mm) | 2.929 | 3.747 | 2.972 | 3.563 | 2.790 | 3.606 |
| d3s (mm) | 2.631 | 2.631 | 2.361 | 2.361 | 2.273 | 2.273 |
| D3s (mm) | 3.230 | 3.832 | 3.273 | 3.967 | 2.872 | 3.706 |
| D3m (mm) | 3.230 | 3.832 | 3.273 | 3.967 | 2.872 | 3.706 |
| d4s (mm) | 2.991 | 2.991 | 2.732 | 2.732 | 2.231 | 2.231 |
| D4s (mm) | 4.234 | 4.294 | 4.277 | 4.277 | 2.973 | 3.805 |
| D4m (mm) | 4.234 | 4.294 | 4.277 | 4.277 | 2.973 | 3.805 |
| d5s (mm) | 3.622 | 3.649 | 3.486 | 3.642 | 2.138 | 2.138 |
| d5m (mm) | 4.041 | 4.059 | 3.967 | 3.833 | 2.094 | 2.094 |
| D5s (mm) | 4.115 | 4.182 | 4.016 | 4.016 | 3.008 | 3.905 |
| D5m (mm) | 4.195 | 4.184 | 4.223 | 4.186 | 3.008 | 3.905 |
| D0s (mm) | 3.683 | 4.587 | 3.580 | 4.718 | 3.837 | 4.194 |
| EP01 (mm) | 0.569 | 0.569 | 0.569 | 0.569 | 0.626 | 0.626 |
| EP12 (mm) | 0.328 | 0.332 | 0.558 | 0.554 | 0.433 | 0.429 |
| EP23 (mm) | 0.386 | 0.382 | 0.688 | 0.684 | 0.443 | 0.439 |
| EP45 (mm) | 0.383 | 0.407 | 0.328 | 0.328 | 0.656 | 0.652 |
| EP56 (mm) | 0.436 | 0.420 | 0.262 | 0.332 | 0.495 | 0.491 |
| CP5 (mm) | 0.376 | 0.367 | 0.307 | 0.237 | 0.018 | 0.022 |
| L (mm) | 3.466 | 3.453 | 4.108 | 4.108 | 3.890 | 3.890 |

In summary, the optical photography lens assemblies in Embodiments 1-6 respectively satisfy the conditions in Table 9 below.

TABLE 9

| conditional | | | | | | |
|---|---|---|---|---|---|---|
| expression/embodiment | 1 | 2 | 3 | 4 | 5 | 6 |
| f1/(D0s − D1s) | −74.21 | −39.93 | −41.33 | −18.32 | −27.80 | −46.54 |
| (EP01 + CT2)/CT1 | 3.96 | 3.96 | 4.79 | 4.79 | 4.49 | 4.49 |
| EP12/CT2 | 0.97 | 0.98 | 1.06 | 1.06 | 0.93 | 0.92 |
| f2*N2/d2s | 6.41 | 6.41 | 6.22 | 6.22 | 5.85 | 5.85 |
| f12/(D2m − d2m) | 16.98 | 7.48 | 12.57 | 7.56 | 17.48 | 7.71 |
| (T23 + CT3 + T34)/EP23 | 1.87 | 1.89 | 1.79 | 1.80 | 1.73 | 1.75 |
| (EP45 + CP5)/CT5 | 1.82 | 1.86 | 2.34 | 2.08 | 1.88 | 1.88 |
| T56/EP56 | 0.94 | 0.98 | 2.08 | 1.64 | 1.35 | 1.36 |
| R1/(d1s − d1m) | 31.35 | 31.35 | 33.06 | 33.06 | 32.05 | 32.05 |
| CT2/CT1 | 1.47 | 1.47 | 2.30 | 2.30 | 1.91 | 1.91 |
| EP12/EP01 | 0.58 | 0.58 | 0.98 | 0.97 | 0.69 | 0.69 |
| D4s/R7 + D4m/R8 | 1.75 | 1.78 | 1.62 | 1.62 | 1.96 | 2.50 |
| R9*N5/D5s | 0.55 | 0.54 | 0.59 | 0.59 | 0.58 | 0.44 |
| f6/d5m | −0.96 | −0.95 | −1.49 | −1.55 | −3.31 | −3.31 |
| L/ΣCT | 1.62 | 1.61 | 1.77 | 1.77 | 1.80 | 1.80 |
| f3/d3s | 3.54 | 3.54 | 4.19 | 4.19 | 3.22 | 3.22 |
| D3s/R5 + D3m/R6 | 1.78 | 2.11 | 2.36 | 2.85 | 2.18 | 2.81 |
| f45/(D4s − d4s) | 2.27 | 2.17 | 4.78 | 4.78 | 6.43 | 3.03 |
| f56/D5m | 0.97 | 0.97 | 2.31 | 2.33 | 1.11 | 0.85 |
| R6/R5 | 1.81 | 1.81 | 1.63 | 1.63 | 1.69 | 1.69 |
| f5/R10 + f5/d5s | 1.18 | 1.17 | 2.98 | 2.92 | 2.44 | 2.44 |

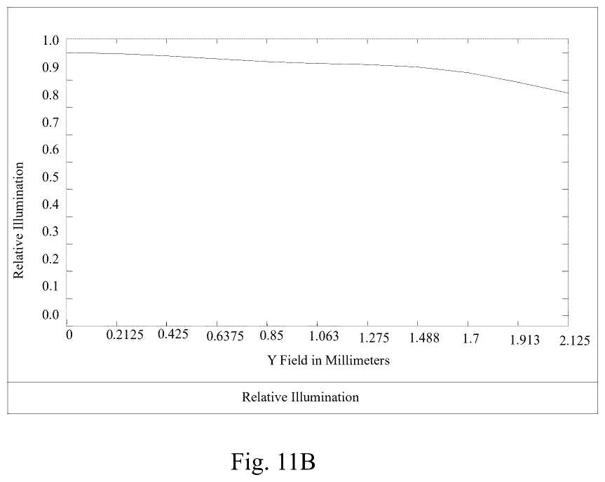

FIG. 11A to FIG. 13 respectively illustrate defocus curves and relative illumination curves of sample 1 and sample 2, and defocus curves of sample 3 of optical photography lens assemblies.

According to sample 1 of the optical photography lens assembly, R6/R5=1.81 and f3/d3s=3.54. It can be seen from FIGS. 11A-11B that, when the optical photography lens assembly satisfies the range of values of 1.5<R6/R5<2.0 and 3.0<f3/d3s<4.2, the optical photography lens assembly has a very small focus shift in the defocus curve and has a high relative illumination.

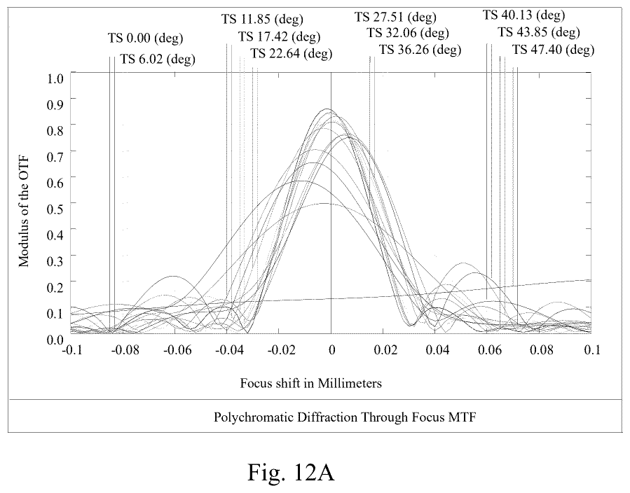

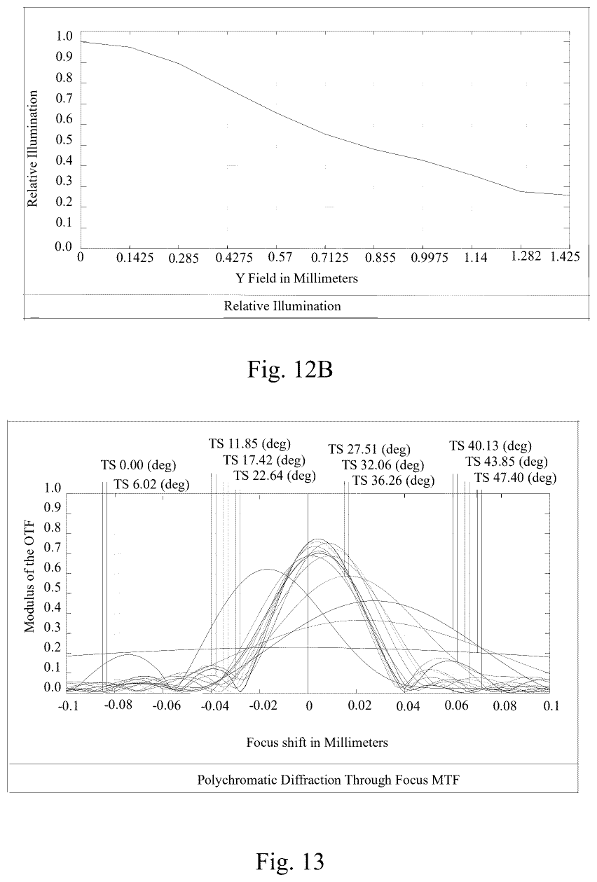

According to sample 2 of the optical photography lens assembly, R6/R5=2.17 and f3/d3s=5.65. It can be seen from FIGS. 12A-12B that, when the optical photography lens assembly exceeds an upper limit of the range of values in the conditional expressions 1.5<R6/R5<2.0 and 3.0<f3/d3s<4.2, the optical photography lens assembly has a focus shift. In addition, when the inner diameter d3s of the object-side surface of the third spacing element is too small, the illumination may be affected by excessive light blockage, and the relative illumination RI drops.

According to sample 3 of the optical photography lens assembly, R6/R5=1.42 and f3/d3s=2.67. It can be seen from FIG. 13 that, when the optical photography lens assembly is below a lower limit of the range of values in the conditional expressions 1.5<R6/R5<2.0 and 3.0<f3/d3s<4.2, the inner diameter d3s of the object-side surface of the third spacing element is too large, which may result in a poorer performance in blocking excess light, and the optical photography lens assembly also shows a severe focus shift.

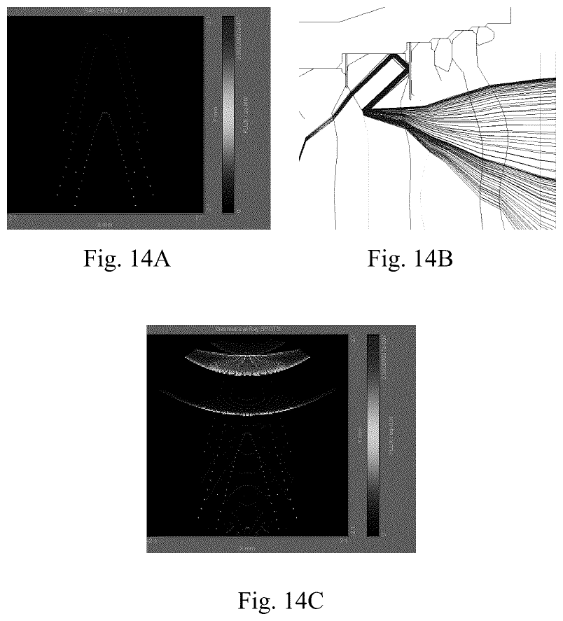

FIGS. 14A-14C illustrate schematic diagrams of stray light of sample 2 according to an optical photography lens assembly. In order to meet the requirements for high resolution and good imaging quality of lens assemblies applied to terminal electronic devices, the lens assemblies need to have small field curvature and low dispersion, and high relative illumination. However, meeting these requirements also results in a sensitive third lens and easy generation of stray light in structural portions, such as stray light spots and stray light paths shown in FIG. 14A and FIG. 14B. When exceeding an upper limit of the range of values of 1.5<R6/R5<2.0 and 3.0<f3/d3s<4.2, as shown in FIG. 14C, ghost images occur in an upper portion of the figure, thereby affecting the imaging quality.

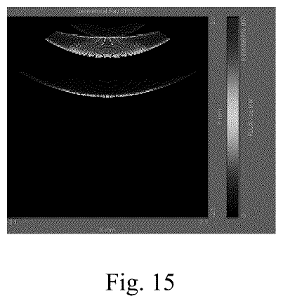

FIG. 15 illustrates a schematic diagram of stray light of sample 1 according to an optical photography lens assembly. When the optical photography lens assembly satisfies the range of values of 1.5<R6/R5<2.0 and 3.0<f3/d3s<4.2, the effect of eliminating stray light is good.

Through some experimental comparisons of different samples of optical photography lens assemblies described above, it can be found that when an optical photography lens assembly satisfies the range of values of 1.5<R6/R5<2.0 and 3.0<f3/d3s<4.2, the effect of intercepting stray light is good, however, when exceeding this range of values, stray light is more likely to occur, or the relative illumination may be affected.

Table 10 below shows results of the experimental comparisons of sample 1, sample 2 and sample 3 of the optical photography lens assemblies.

TABLE 10

| | sample 1 | sample 2 | sample 3 |
|---|---|---|---|
| | R6/R5 = 1.81, | R6/R5 = 2.17, | R6/R5 = 1.42, |
| scheme | f3/d3s = 3.54 | f3/d3s = 5.65 | f3/d3s = 2.67 |
| defocus | qualified | unqualified | unqualified |
| curve | | | |
| relative | qualified | unqualified | unqualified |
| illumination | | | |
| status | qualified | unqualified | unqualified |

Therefore, by making the optical photography lens assembly satisfy the range of values in the conditional expressions 1.5<R6/R5<2.0 and 3.0<f3/d3s<4.2, is conducive to improving the field curvature of the optical structure and correcting aberrations, so that the lens assembly has a small field curvature, a low dispersion, and a high RI, while reducing the sensitivity of the third lens, and improving stray light in a structural area of the third lens.

The foregoing is only a description for the preferred embodiments of the present disclosure and the applied technical principles. It should be appreciated by those skilled in the art that the scope of protection of the present disclosure is not limited to the technical solution formed by the particular combination of the above technical features. The scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical photography lens assembly, comprising a lens barrel having an accommodation space, and a lens group and at least one spacing element accommodated within the lens barrel, wherein,
the lens group comprises: a first lens having a refractive power, a second lens having a refractive power, a third lens having a refractive power, a fourth lens having a refractive power, a fifth lens having a refractive power, and a sixth lens having a refractive power, disposed sequentially along an optical axis from an object side to an image side;
the at least one spacing element comprises a third spacing element disposed between the third lens and the fourth lens and in direct contact with an image side of the third lens;
wherein, a radius of curvature R5 of an object-side surface of the third lens and a radius of curvature R6 of an image-side surface of the third lens satisfy: 1.5<R6/R5<2.0; and
an effective focal length f3 of the third lens and an inner diameter d3s of an object-side surface of the third spacing element satisfy: 3.2<f3/d3s<4.2.

2. The optical photography lens assembly according to claim 1, wherein the at least one spacing element further comprises a fifth spacing element disposed between the fifth lens and the sixth lens and in direct contact with an image side of the fifth lens, and
a radius of curvature R10 of an image-side surface of the fifth lens, a refractive index N5 of the fifth lens, and an inner diameter d5s of an object-side surface of the fifth spacing element satisfy: −75.0<R10*N5/d5s<−18.0.

3. The optical photography lens assembly according to claim 1, wherein the at least one spacing element further comprises a first spacing element disposed between the first lens and the second lens and in direct contact with an image side of the first lens, and
a spacing EP01 between a front-end surface of the lens barrel and the first spacing element, a center thickness CT1 of the first lens on the optical axis and a center thickness CT2 of the second lens on the optical axis satisfy: 3.5< (EP01+CT2)/CT1<5.0.

4. The optical photography lens assembly according to claim 1, wherein the at least one spacing element further comprises a first spacing element disposed between the first lens and the second lens and in direct contact with an image side of the first lens, and a second spacing element disposed between the second lens and the third lens and in direct contact with an image side of the second lens, and
a spacing EP12 between the first spacing element and the second spacing element, a center thickness CT1 of the first lens on the optical axis and a center thickness CT2 of the second lens on the optical axis satisfy: 0.9<EP12/CT2<1.1; and 1.4<CT2/CT1≤2.3.

5. The optical photography lens assembly according to claim 1, wherein the at least one spacing element further comprises a second spacing element disposed between the second lens and the third lens and in direct contact with an image side of the second lens, and
an effective focal length f2 of the second lens, a refractive index N2 of the second lens and an inner diameter d2s of an object-side surface of the second spacing element satisfy: 5.5<f2*N2/d2s<6.5.

6. The optical photography lens assembly according to claim 1, wherein the at least one spacing element further comprises a second spacing element disposed between the second lens and the third lens and in direct contact with an image side of the second lens, and
a combined focal length f12 of the first lens and the second lens, an outer diameter D2m of an image-side surface of the second spacing element, and an inner diameter d2m of the image-side surface of the second spacing element satisfy: 7.0<f12/(D2m-d2m) <17.5.

7. The optical photography lens assembly according to claim 1, wherein the at least one spacing element further comprises a second spacing element disposed between the second lens and the third lens and in direct contact with an image side of the second lens, and
an air spacing T23 between the second lens and the third lens on the optical axis, an air spacing T34 between the third lens and the fourth lens on the optical axis, a center thickness CT3 of the third lens on the optical axis, and a spacing EP23 between the second spacing element and the third spacing element satisfy: 1.5< (T23+CT3+T34)/EP23<2.0.

8. The optical photography lens assembly according to claim 1, wherein the at least one spacing element further comprises a fourth spacing element disposed between the fourth lens and the fifth lens and in direct contact with an image side of the fourth lens, and a fifth spacing element disposed between the fifth lens and the sixth lens and in direct contact with an image side of the fifth lens, and
a spacing EP45 between the fourth spacing element and the fifth spacing element, a maximal thickness CP5 of the fifth spacing element, and a center thickness CT5 of the fifth lens on the optical axis satisfy: 1.5< (EP45+CP5)/CT5<2.5.

9. The optical photography lens assembly according to claim 1, wherein the at least one spacing element further comprises a fifth spacing element disposed between the fifth lens and the sixth lens and in direct contact with an image side of the fifth lens, and a sixth spacing element disposed an image side of the sixth lens and in direct contact with the image side of the sixth lens, and
an air spacing T56 between the fifth lens and the sixth lens on the optical axis and a spacing EP56 between the fifth spacing element and the sixth spacing element satisfy: 0.9<T56/EP56<2.1.

10. The optical photography lens assembly according to claim 1, wherein the at least one spacing element further comprises a first spacing element disposed between the first lens and the second lens and in direct contact with an image side of the first lens, and
a radius of curvature R1 of an object-side surface of the first lens, an inner diameter d1s of an object-side surface of the first spacing element, and an inner diameter d1m of an image-side surface of the first spacing element satisfy: 31.0<R1/(d1s−d1m)<33.5.

11. The optical photography lens assembly according to claim 1, wherein the at least one spacing element further comprises the first spacing element disposed between the first lens and the second lens and in direct contact with the image side of the first lens, and a second spacing element disposed between the second lens and the third lens and in direct contact with an image side of the second lens, and
a spacing EP12 between the first spacing element and the second spacing element and the spacing EP01 between the front-end surface of the lens barrel and the first spacing element satisfy: 0.5<EP12/EP01<1.0.

12. The optical photography lens assembly according to claim 1, wherein the at least one spacing element further comprises a fourth spacing element disposed between the fourth lens and the fifth lens and in direct contact with an image side of the fourth lens, and
a radius of curvature R7 of an object-side surface of the fourth lens, a radius of curvature R8 of an image-side surface of the fourth lens, an outer diameter D4s of an object-side surface of the fourth spacing element, and an outer diameter D4m of an image-side surface of the fourth spacing element satisfy: 1.5<D4s/R7+D4m/R8≤2.5.

13. The optical photography lens assembly according to claim 1, wherein the at least one spacing element further comprises a fifth spacing element disposed between the fifth lens and the sixth lens and in direct contact with an image side of the fifth lens, and
a radius of curvature R9 of an object-side surface of the fifth lens, a refractive index N5 of the fifth lens, and an outer diameter D5s of an object-side surface of the fifth spacing element satisfy: 0.4<R9*N5/D5s<0.6.

14. The optical photography lens assembly according to claim 1, wherein the at least one spacing element further comprises a fifth spacing element disposed between the fifth lens and the sixth lens and in direct contact with an image side of the fifth lens, and
an effective focal length f6 of the sixth lens and an inner diameter d5m of an image-side surface of the fifth spacing element satisfy: −3.5<f6/d5m<−0.9.

15. The optical photography lens assembly according to claim 1, wherein a maximal height L of the lens barrel along a direction of the optical axis and a sum of center thicknesses ΣCT of all lenses in the lens group on the optical axis satisfy: 1.6<L/ΣCT<1.8.

16. The optical photography lens assembly according to claim 1, wherein an outer diameter D3s of the object-side surface of the third spacing element, the radius of curvature R5 of the object-side surface of the third lens, the radius of curvature R6 of the image-side surface of the third lens, and an outer diameter D3m of an image-side surface of the third spacing element satisfy: 1.7<D3s/R5+D3m/R6<2.9.

17. The optical photography lens assembly according to claim 1, wherein the at least one spacing element further comprises the fourth spacing element disposed between the fourth lens and the fifth lens and in direct contact with the image side of the fourth lens, and
a combined focal length f45 of the fourth lens and the fifth lens, the outer diameter D4s of the object-side surface of the fourth spacing element, and an inner diameter d4s of the object-side surface of the fourth spacing element satisfy: 2.0<f45/(D4s-d4s) <6.5.

18. The optical photography lens assembly according to claim 1, wherein the at least one spacing element further comprises a fifth spacing element disposed between the fifth lens and the sixth lens and in direct contact with an image side of the fifth lens, and
a combined focal length f56 of the fifth lens and the sixth lens and an outer diameter D5m of an image-side surface of the fifth spacing element satisfy: 0.8<f56/D5m<2.4.

19. The optical photography lens assembly according to claim 1, wherein the at least one spacing element further comprises a fifth spacing element disposed between the fifth lens and the sixth lens and in direct contact with an image side of the fifth lens, and
an effective focal length f5 of the fifth lens, a radius of curvature R10 of an image-side surface of the fifth lens, and an inner diameter d5s of an object-side surface of the fifth spacing element satisfy: 1.1<f5/R10+f5/d5s<3.0.
